(19) United States
(12) Patent Application Publication
(10) Pub. No.: US 2008/0237914 A1
(43) Pub. Date: Oct. 2, 2008

(54) Methods for making fiber reinforced polypropylene composites using pre-cut fiber

(76) Inventors: Arnold Lustiger, Edison, NJ (US); Jennifer Harting Ward, Houston, TX (US); Patrick Bormann, Caudebec (FR); David Jon Starz, Baytown, TX (US); Alan J. Oshinski, League City, TX (US)

Correspondence Address: ExxonMobil Research and Engineering Company, P. O. Box 900, Annandale, NJ, 08801-0900, US

(21) Appl. No.: 12/079,340

(22) Filed: Mar. 26, 2008

Related U.S. Application Data
(63) Continuation-in-part of application No. 11/301,533, filed on Dec. 13, 2005.
Application No. 11/301,533 is a continuation-in-part of application No. 11/318,363, filed on Dec. 23, 2005.
(60) Provisional application No. 60/921,021, filed on Mar. 30, 2007.

(51) Int. Cl. B29B 9/06; B29C 47/60

(52) U.S. Cl. 264/143

(57) ABSTRACT

The present disclosure is directed generally to methods for making fiber reinforced polypropylene composite pellets using pre-cut fiber fed to a compounding extruder by improved fiber feeder systems. One form of the method includes feeding into a compounding extruder at least 25 wt % polypropylene based polymer, from 5 to 60 wt % pre-cut organic fiber, and from 0 to 60 wt % inorganic filler; and extruding, cooling and pelletizing the resultant mixture of components to form fiber reinforced polypropylene composite pellets; wherein the pre-cut organic fiber is fed from a feeder including a feeder hopper, one or more conditioning augers/agitators, one or more metering augers below the feeder hopper, and a means for controlling the speed of the conditioning augers/agitators and metering augers; and wherein an article molded from the pellets has a flexural modulus of at least 2.07 GPa and exhibits ductility during instrumented impact testing. In another form, the feeder includes a feeder hopper, two or more counter-rotating metering rollers, one or more separating rollers below the metering rollers, and a means for controlling the speed of the metering rollers and separating rollers. In yet another form, a circle feeder may be used to feed the pre-cut fiber.

### CROSS-REFERENCE TO RELATED APPLICATIONS

This application is a Continuation-in-Part of U.S. patent application Ser. No. 11/301,533 filed on Dec. 13, 2005, and is also a Continuation-in-Part of U.S. patent application Ser. No. 11/318,363 filed on Dec. 23, 2005 and claims priority to U.S. Provisional Application No. 60/921,021 filed on Mar. 30, 2007.

### FIELD

The present disclosure is directed generally to methods for making fiber reinforced polypropylene compositions and articles made from such compositions having a flexural modulus of at least 300,000 psi and exhibiting ductility during instrumented impact testing. More particularly, the present disclosure relates to methods for feeding pre-cut fiber into a compounding process to uniformly and randomly disperse the fiber into the polypropylene matrix.

### BACKGROUND

Polyolefins have limited use in engineering applications due to the tradeoff between toughness and stiffness. For example, polyethylene is widely regarded as being relatively tough, but low in stiffness. Polypropylene generally displays the opposite trend, i.e., is relatively stiff, but low in toughness.

Several well known polypropylene compositions have been introduced which address toughness. For example, it is known to increase the toughness of polypropylene by adding rubber particles, either in-reactor resulting in impact copolymers, or through post-reactor blending. However, while toughness is improved, the stiffness is considerably reduced using this approach.

Glass reinforced polypropylene compositions have been introduced to improve stiffness. However, the glass fibers have a tendency to break in typical injection molding equipment, resulting in reduced toughness and stiffness. In addition, glass reinforced products have a tendency to warp after injection molding.

Another known method of improving physical properties of polyolefins is organic fiber reinforcement. For example, EP Patent Application 0397881, the entire disclosure of which is hereby incorporated herein by reference, discloses a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., the entire disclosure of which is hereby incorporated herein by reference, discloses a composition including a polymer, such as polypropylene, and uniformly dispersed therein at least about 10% by weight of the composition staple length fiber, the fiber being of man-made polymers, such as poly(ethylene terephthalate) or poly(1,4-cyclohexylenedimethylene terephthalate).

Fiber reinforced polypropylene compositions are also disclosed in PCT Publication WO02/053629, the entire disclosure of which is hereby incorporated herein by reference. More specifically, WO02/053629 discloses a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

U.S. Pat. No. 3,304,282 to Cadus et al. discloses a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent discloses an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. discloses a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. discloses an impregnation process for preparing pellets of a synthetic organic fiber reinforced polyolefin. The process comprises the steps of heating a polyolefin at the temperature which is higher than the melting point thereof by 40 degree C. or more to lower than the melting point of a synthetic organic fiber to form a molten polyolefin; passing a reinforcing fiber comprising the synthetic organic fiber continuously through the molten polyolefin within six seconds to form a polyolefin impregnated fiber; and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. discloses a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

Consistently feeding pre-cut organic fibers into a compounding extruder is an issue encountered during the production of fiber reinforced polypropylene composites. Gravimetric or volumetric type screw or auger feeders are used in the metering and conveying of polymers, fillers and additives into the extrusion compounding process. These feeders are designed to convey materials at a constant rate using a single or twin screw type of auger mechanism by measuring the weight loss in the hopper of the feeder or the volume of additive fed to the compounding extruder. These feeders are effective in conveying pellets or powder, but are generally not effective in conveying cut organic fiber. Two issues are generally encountered with traditional gravimetric or volumetric additive feeders when feeding cut organic fiber.

The first issue is that the cut fiber tends to bridge in the feed throat leading from the feeder hopper to the feeder metering auger or screw. This results in a non-uniform rate of fiber feeding the feeder screw or auger, which necessarily results in an inconsistent fiber feed rate to the compounding process. More particularly, at certain times, fiber gets hung up in the feeder throat area and little fiber is conveyed by the feeder, while at other times, an overabundance of fiber is conveyed to the compounding extruder. FIG. 1 is an illustrative plot of the feed rate of ¼ inch chopped polyester fiber through a typical single screw type gravimetric feeder (prior art). The feed rate may vary anywhere from 3 to 18 grams per 5 seconds of feeding. This inconsistency is less than adequate to produce a fiber reinforced polypropylene in an extruder with a consistent percentage of fiber incorporated into the polypropylene based resin.

A second issue encountered with typical gravimetric or volumetric additive feeders is that the pre-cut fiber has a tendency to clump at the end of the screw type auger of the feeder resulting in the fiber dropping in large clumps into the compounding extruder. These large pre-cut fiber clumps result in fiber feed rate inconsistency to the compounding extruder. This makes dispersion of the organic fiber into the polypropylene matrix more difficult because of the greater work the compounding extruder must do to uniformly disperse the organic fiber. It may also lead to variations in the fiber loading in the polypropylene composite as a function of time, which correspondingly may results in a variation in properties of the resultant articles molded from the composite pellets.

A need exists for improved methods of feeding pre-cut fibers into a compounding extruder for making fiber reinforced polypropylene composites. More particularly, a need exists for improved methods of feeding organic fiber into the polypropylene based resin during the compounding process while still maintaining the advantageous effects of the organic fiber on impact resistance and flexural modulus of parts molded from the composite resin pellets.

### SUMMARY

Provided are methods for making fiber reinforced polypropylene based composites by improved feeding of cut or chopped organic fiber into a compounding extruder.

In one aspect of the present disclosure, provided is a method for making fiber reinforced polypropylene composite pellets including the following: feeding into a compounding extruder at least 25 wt % polypropylene based polymer, from 5 to 60 wt % pre-cut organic fiber, and from 0 to 60 wt % inorganic filler, based on the total weight of the composition; extruding the polypropylene based resin, the pre-cut organic fiber, and the inorganic filler through the compounding extruder to form a fiber reinforced polypropylene composite melt; cooling the fiber reinforced polypropylene composite melt to form a solid fiber reinforced polypropylene composite, and pelletizing the solid fiber reinforced polypropylene composite to form fiber reinforced polypropylene composite pellets; wherein the pre-cut organic fiber is fed from a feeder including a feeder hopper, one or more conditioning augers/agitators within the feeder hopper, one or more metering augers below the feeder hopper within a housing, and a means for controlling the speed of the conditioning agitators and metering augers; and wherein an article molded from the pellets has a flexural modulus of at least 2.07 GPa and exhibits ductility during instrumented impact testing.

In another aspect of the present disclosure, provided is a method for making fiber reinforced polypropylene composite pellets including the following: feeding into a compounding extruder at least 25 wt % polypropylene based polymer, from 5 to 60 wt % pre-cut organic fiber, and from 0 to 60 wt % inorganic filler, based on the total weight of the composition; extruding the polypropylene based resin, the pre-cut organic fiber, and the inorganic filler through the compounding extruder to form a fiber reinforced polypropylene composite melt; cooling the fiber reinforced polypropylene composite melt to form a solid fiber reinforced polypropylene composite, and pelletizing the solid fiber reinforced polypropylene composite to form fiber reinforced polypropylene composite pellets; wherein the pre-cut organic fiber is fed from a feeder including a feeder hopper, two or more counter-rotating metering rollers within a housing below the feeder hopper, one or more separating rollers within the housing below the metering rollers, and a means for controlling the speed of the metering rollers and separating rollers; and wherein an article molded from the pellets has a flexural modulus of at least 2.07 GPa and exhibits ductility during instrumented impact testing.

In another aspect, provided is a method for making fiber reinforced polypropylene composite pellets including the following: feeding into a twin screw compounding extruder at least 25 wt % polypropylene based polymer, from 5 to 40 wt % pre-cut polyethylene terephthalate (PET) fiber with a length of from 3.2 to 25.4 mm, and from 5 to 60 wt % talc, based on the total weight of the composition; extruding the polypropylene based resin, the pre-cut PET fiber, and the talc through the twin screw compounding extruder to form a fiber reinforced polypropylene composite melt; cooling the fiber reinforced polypropylene composite melt to form a solid fiber reinforced polypropylene composite, and pelletizing the solid fiber reinforced polypropylene composite to form fiber reinforced polypropylene composite pellets; wherein the pre-cut PET fiber is fed from a feeder including a feeder hopper, one or more conditioning augers/agitators within the feeder hopper, one or more metering augers below the feeder hopper within a housing, one or more rotating pickers positioned downstream of the one or more metering augers, and a means for controlling the speed of the conditioning augers/agitators and metering augers; and wherein an article molded from the pellets has a flexural modulus of at least 2.07 GPa and exhibits ductility during instrumented impact testing.

In another aspect, provided is a method for making fiber reinforced polypropylene composite pellets including the following: feeding into a twin screw compounding extruder at least 25 wt % polypropylene based polymer, from 5 to 40 wt % pre-cut polyethylene terephthalate (PET) fiber with a length of from 3.2 to 25.4 mm, and from 5 to 60 wt % talc, based on the total weight of the composition; extruding the polypropylene based resin, the pre-cut PET fiber, and the talc through the twin screw compounding extruder to form a fiber reinforced polypropylene composite melt; cooling the fiber reinforced polypropylene composite melt to form a solid fiber reinforced polypropylene composite, and pelletizing the solid fiber reinforced polypropylene composite to form fiber reinforced polypropylene composite pellets; wherein the pre-cut PET fiber is fed from a feeder including a feeder hopper, one or more conditioning augers/agitators within the feeder hopper, one or more metering augers below the feeder hopper within a housing, one or more rotating pickers positioned downstream of the one or more metering augers, and a means for controlling the speed of the conditioning augers/agitators and metering augers; and wherein an article molded from the pellets has a flexural modulus of at least 2.07 GPa and exhibits ductility during instrumented impact testing.

In still another aspect, provided is a method for making fiber reinforced polypropylene composite pellets including the following: feeding into a compounding extruder at least 25 wt % polypropylene based polymer, from 5 to 60 wt % pre-cut organic fiber, and from 0 to 60 wt % inorganic filler, based on the total weight of the composition; extruding the polypropylene based resin, the pre-cut organic fiber, and the inorganic filler through the compounding extruder to form a fiber reinforced polypropylene composite melt; cooling the fiber reinforced polypropylene composite melt to form a solid fiber reinforced polypropylene composite, and pelletizing the solid fiber reinforced polypropylene composite to form fiber reinforced polypropylene composite pellets; wherein the pre-cut organic fiber is fed from a feeder including a feeder hopper with a means for vibrating the hopper, one or more metering augers below the feeder hopper within a housing, and a means for controlling the speed of the metering augers; and wherein an article molded from the pellets has a flexural modulus of at least 2.07 GPa and exhibits ductility during instrumented impact testing.

In still yet another aspect, provided is a method for making fiber reinforced polypropylene composite pellets including the following: feeding into a compounding extruder at least 25 wt % polypropylene based polymer, from 5 to 60 wt % pre-cut organic fiber, and from 0 to 60 wt % inorganic filler, based on the total weight of the composition; extruding the polypropylene based resin, the pre-cut organic fiber, and the inorganic filler through the compounding extruder to form a fiber reinforced polypropylene composite melt; cooling the fiber reinforced polypropylene composite melt to form a solid fiber reinforced polypropylene composite, and pelletizing the solid fiber reinforced polypropylene composite to form fiber reinforced polypropylene composite pellets; wherein the pre-cut organic fiber is fed from a circle feeder including a circle feeder hopper positioned above the circle feeder; and wherein an article molded from the pellets has a flexural modulus of at least 2.07 GPa and exhibits ductility during instrumented impact testing.

Numerous advantages result from the methods of making the fiber reinforced polypropylene composite pellets disclosed herein and the uses/applications therefore.

For example, in exemplary forms disclosed herein, the methods of making the fiber reinforced polypropylene composite pellets exhibit higher feed rates into a compounding extruder than feeding continuous fiber from spools.

In a further exemplary form disclosed herein, the methods of making the fiber reinforced polypropylene composite pellets exhibit improved feed rate consistency of organic fiber into the compounding extruder.

In a further exemplary form disclosed herein, the methods of making the fiber reinforced polypropylene composite pellets exhibit uniform dispersion of the organic fiber in the pellets.

In a further exemplary form disclosed herein, the methods of making the fiber reinforced polypropylene composite pellets do not exhibit bridging in the fiber feed hopper throat prior to being fed into the compounding extruder.

In a further exemplary form disclosed herein, the methods of making the fiber reinforced polypropylene composite pellets exhibit little to no clumping of the fiber at the end of the fiber feeder screw before falling into the compounding extruder.

In a further exemplary form disclosed herein, the methods of making the fiber reinforced polypropylene composite pellets exhibit separation of fibers upon entering the compounding extruder and no fiber degradation.

In a further exemplary form disclosed herein, the methods of making the fiber reinforced polypropylene composite pellets result in molded articles that do not splinter during instrumented impact testing.

In yet a further exemplary form of the present disclosure, the methods of making the fiber reinforced polypropylene composite pellets result in molded articles that exhibit fiber pull out during instrumented impact testing without the need for lubricant additives.

In yet a further exemplary form of the present disclosure, the methods of making the fiber reinforced polypropylene composite pellets result in molded articles that exhibit a higher heat distortion temperature compared to rubber toughened polypropylene.

In yet a further exemplary form of the present disclosure, the methods of making the fiber reinforced polypropylene composite pellets result in molded articles that exhibit a lower flow and cross flow coefficient of linear thermal expansion compared to rubber toughened polypropylene.

In still yet a further exemplary form of the present disclosure, the methods of making the fiber reinforced polypropylene composite pellets result in molded articles that exhibit a flexural modulus of at least 300,000 psi.

In still yet a further exemplary form of the present disclosure, the methods of making the fiber reinforced polypropylene composite pellets result in molded articles that are particularly suitable for household appliances, automotive parts, and boat hulls.

These and other features and attributes of the disclosed methods for making fiber reinforced polypropylene composite resin pellets and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 depicts the feed rate through a typical gravimetric feeder when feeding chopped ¼ inch PET fiber (prior art method).

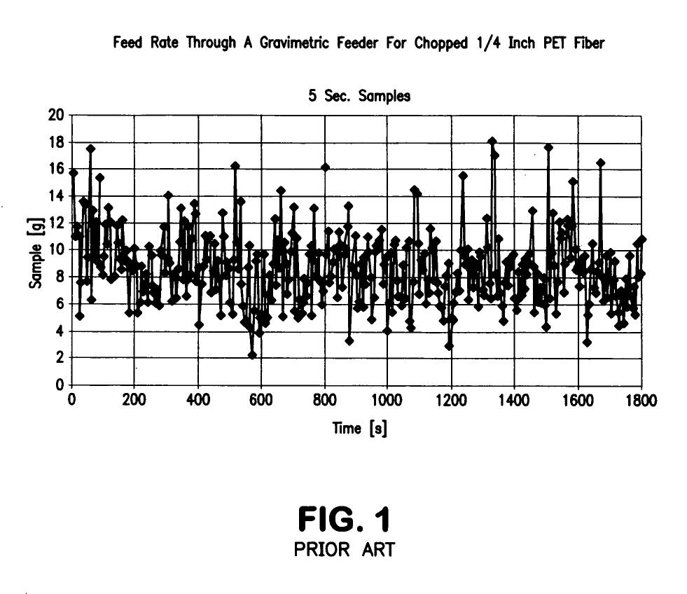

FIG. 2 depicts one form of the process for making fiber reinforced polypropylene composite resin pellets of the present disclosure using chopped or cut fiber fed from a feeder into the hopper of a compounding extruder.

FIG. 3 depicts another form of the process for making fiber reinforced polypropylene composite resin pellets of the present disclosure using chopped or cut fiber fed from a feeder into a downstream feed port of a compounding extruder.

FIG. 4 depicts one form of a twin screw extruder screw configuration for making fiber reinforced polypropylene composites of the present disclosure.

FIG. 5 depicts one form of a feeder for feeding organic fiber of the present disclosure that includes a conditioning agitator and a metering auger.

FIG. 6 depicts another form of a feeder for feeding organic fiber of the present disclosure that includes a single conditioning auger/agitator and a metering auger.

FIG. 7 depicts yet another form of a feeder for feeding organic fiber of the present disclosure that includes two conditioning auger/agitators and a metering auger.

FIG. 8 depicts still yet another form of a feeder for feeding organic fiber of the present disclosure that includes metering and separating rollers.

FIG. 9 depicts one form of the metering and separating rollers of the fiber feeder depicted in FIG. 8.

FIG. 10 depicts still yet another form of a feeder for feeding pre-cut organic fiber of the present disclosure that is referred to as a circle feeder.

### DETAILED DESCRIPTION

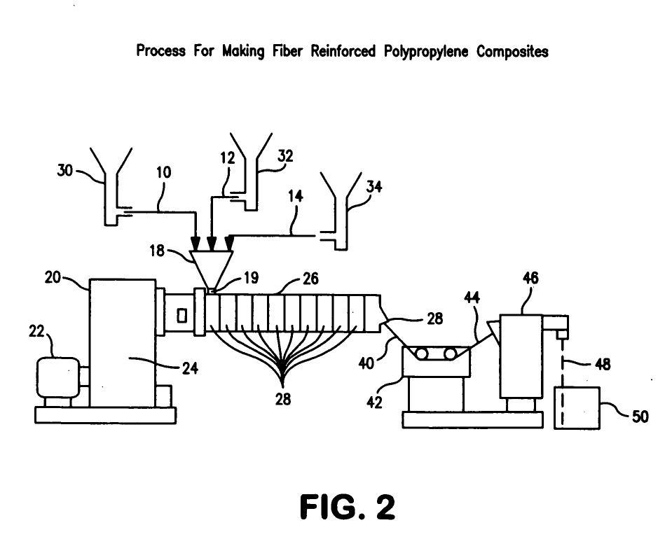

Disclosed herein are methods for making fiber reinforced polypropylene based composite pellets by improved feeding methods of pre-cut or chopped organic fiber into a compounding extruder. Reference is now made to FIGS. 2-9, wherein like numerals are used to designate like parts throughout. All numerical values within the detailed description and the claims herein are understood as modified by “about.”

The present disclosure relates to improved methods for making PET fiber reinforced polypropylene composite resin pellets. The methods of making PET fiber reinforced polypropylene resin pellets of the present disclosure are distinguishable over the prior art in comprising a combination of a polypropylene based matrix with organic polymeric fiber and optional inorganic filler, wherein the pre-cut fiber is fed into the compounding extruder using improved fiber feeding systems. The fiber reinforced polypropylene resin pellets yield articles molded from the pellets with a flexural modulus of at least 300,000 psi and ductility during instrumented impact testing (15 mph, −29° C., 25 lbs). The fiber reinforced polypropylene compositions of the present disclosure also comprise a polypropylene based matrix polymer with an advantageous high melt flow rate without sacrificing impact resistance and that do not splinter during instrumented impact testing.

U.S. patent application Ser. No. 11/301,533 filed on Dec. 13, 2005, herein incorporated by reference in its entirety, discloses advantageous fiber reinforced polypropylene compositions. The fiber reinforced polypropylene compositions include at least 25 wt % polypropylene based polymer, from 5 to 60 wt % organic fiber, and from 0 to 60 wt % inorganic filler. Articles molded from these fiber reinforced polypropylene compositions have a flexural modulus of at least 300,000 psi, and exhibit ductility during instrumented impact testing.

U.S. patent application Ser. No. 11/318,363 filed on Dec. 23, 2005, herein incorporated by reference in its entirety, discloses advantageous processes for making fiber reinforced polypropylene resins including at least 25 wt % polypropylene based polymer, from 5 to 60 wt % organic fiber, and from 0 to 60 wt % inorganic filler. The process includes extrusion compounding the polypropylene based polymer, the organic fiber, and the inorganic filler to form pellets, which are subsequently molded to form an article with a flexural modulus of at least 300,000 psi, and that exhibits ductility during instrumented impact testing. The organic fiber may be fed to the extruder in the form of either chopped fiber or as continuous fiber unwound from spools fed into the hopper of the extrusion compounder.

U.S. patent application Ser. No. 11/395,493 filed on Mar. 31, 2006, herein incorporated by reference in its entirety, discloses cloth-like fiber reinforced polypropylene compositions, and the beneficial mechanical and aesthetic properties imparted by such compositions. The cloth-like fiber reinforced polypropylene compositions include at least 25 wt % polypropylene based polymer, from 5 to 60 wt % organic reinforcing fiber, from 0 to 60 wt % inorganic filler, and from 0.1 to 2.5 wt % colorant fiber. Articles molded from these fiber reinforced polypropylene compositions have a flexural modulus of at least 300,000 psi, exhibit ductility during instrumented impact testing, and exhibit a cloth-like appearance.

U.S. patent application Ser. No. 11/435,578 filed on May 17, 2006, herein incorporated by reference in its entirety, discloses an in-line compounding and molding process for making fiber reinforced polypropylene composites. The in-line compounding and molding process includes the steps of providing an in-line compounding and molding machine comprising a twin screw extruder fluidly coupled to an injection molder; extrusion compounding in the twin screw extruder a composition comprising at least 30 wt % polypropylene, from 10 to 60 wt % organic fiber, from 0 to 40 wt % inorganic filler, and from 0 to 0.1 wt % lubricant to form a melt extrudate; conveying the melt extrudate to the injection molder; and molding the melt extrudate in the injection molder to form a part or article.

U.S. Patent Application Express Mail No. EB250987278US, filed on Mar. 9, 2007, herein incorporated by reference in its entirety, discloses polyester fiber reinforced polypropylene resin pellets and methods for producing therein including at least 25 wt % polypropylene based polymer; from 10 to 40 wt % polyester fiber; from 0 to 60 wt % inorganic filler; and from 0 to 0.2 wt % lubricant. Articles molded from the polyester fiber reinforced polypropylene resin pellets exhibit a drop dart impact resistance that is dependent on the pellet length and whether the PET fiber is incorporated as chopped fiber or continuous fiber during the extrusion compounding process.

### Methods of Making Fiber Reinforced Polypropylene Composite Resin Pellets:

The fiber reinforced polypropylene composites disclosed herein include a polypropylene based polymer, a pre-cut organic fiber, and optional inorganic filler. The fiber reinforced polypropylene resin pellet compositions disclosed herein are not limited by any particular method for forming the compositions. One advantageous process for forming the compositions is by contacting polypropylene, organic fiber, and optional inorganic filler in an extrusion compounding process. In one form, the extrusion compounding process may utilize a single screw compounding extruder and in another form, the extrusion compounding process may utilize a twin screw compounding extruder. In a particular aspect of these forms disclosed herein, the organic fiber is pre-cut (i.e. fed as chopped filament or staple fiber) prior to being fed into the extruder hopper or alternatively fed to the compounding extruder via a downstream feed port. The extrusion compounding process forms one or more strands of fiber reinforced polypropylene composites that are then cut through a pelletizing process into resin pellets of the desired length.

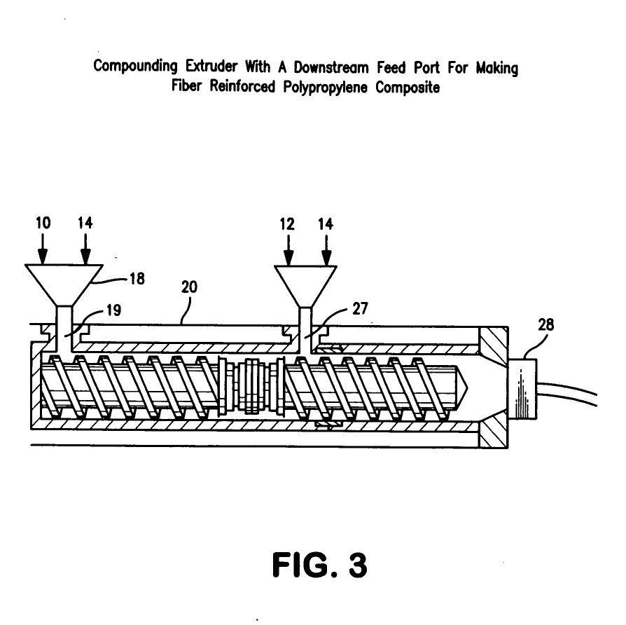

FIG. 2 depicts an exemplary schematic of one form of the process for making fiber reinforced polypropylene resin pellets of the present disclosure. Polypropylene based resin 10, inorganic filler 12, and organic polymeric fiber 14 in the form of pre-cut staple or chopped filament are fed into the extruder hopper 18 of a compounding extruder 20 (single or twin screw type). The extruder hopper 18 is positioned above the feed throat 19 of the compounding extruder 20. The extruder hopper 18 may alternatively be provided with an auger or agitator (not shown) for mixing the polypropylene based resin 10, the inorganic filler 12, and the chopped fiber 14 prior to entering the feed throat 19 of the compounding extruder 20. In an alternative embodiment, as depicted in FIG. 3, the inorganic filler 12 and/or pre-cut fiber 14 may be fed to the compounding extruder 20 at a downstream feed or injection port 27 in the compounding extruder barrel 26 positioned downstream of the extruder hopper 18 while the remaining components 10 are metered into the extruder hopper 18. When utilizing chopped fiber 14, it may be advantageous to feed the fiber at a downstream feed port 27 as compared to the extruder hopper 18 to avoid excessive thermal degradation, and shear induced degradation through the compounding extruder. In an alternative embodiment, the inorganic filler 12, and/or the chopped fiber 14 may be fed to a combination of the extruder hopper 18 and one or more downstream feed ports 27. This may provide for the ability to feed higher loadings of inorganic filler 12, and/or the chopped fiber 14 into the compounding extruder 20.

Referring again to FIG. 2, the polypropylene based resin 10 is metered to the extruder hopper 18 via a feed system 30 for accurately controlling the feed rate. Similarly, the inorganic filler 12 is metered to the extruder hopper 18 via a feed system 32 for accurately controlling the feed rate. Similarly, the chopped fiber 14 is metered to the extruder hopper 18 via a feed system 34 for accurately controlling the feed rate. The feed systems 30, 32, 34 may be, but are not limited to, gravimetric feed systems or volumetric feed systems. Gravimetric feed systems are advantageous for accurately controlling the weight percentage of polypropylene based resin 10, inorganic filler 12 and pre-cut fiber 14 being fed to the extruder hopper 18.

With regard to downstream feeding of the inorganic filler and/or chopped organic fiber depicted in FIG. 3, one or more feed systems (not shown and to be discussed in detail below) are used for accurately controlling the feed rate of the inorganic filler 12 and/or chopped fiber 14 fed to the compounding extruder 20 at the downstream feed port 27. Again, the feed systems (not shown) may be, but are not limited to, gravimetric feed systems or volumetric feed systems.

Referring again to FIG. 2, the compounding extruder 20 includes a drive motor 22, a gear box 24, an extruder barrel 26 for holding one or two screws (not shown), and a strand die 28. The extruder barrel 26 is segmented into a number of heated temperature controlled zones 28. As depicted in FIG. 2, the extruder barrel 26 includes a total of ten temperature control zones 28. In one embodiment, the compounding extruder is a twin screw type. The two screws within the extruder barrel 26 of the compounding extruder 20 may be intermeshing or non-intermeshing, and may rotate in the same direction (co-rotating) or rotate in opposite directions (counter-rotating). From a processing perspective, the melt temperature should be maintained above the melting point of the polypropylene based resin 10, and below the melting temperature of the pre-cut organic fiber 14, such that the mechanical properties imparted by the fiber 14 may be maintained when mixed into the polypropylene based resin 10. In one exemplary embodiment, the barrel temperature of the extruder zones do not exceed 154° C. when extruding PP homopolymer and PET fiber, which yields a melt temperature above the melting point of the PP homopolymer, but significantly below the melting point of the PET fiber. In another exemplary embodiment, the barrel temperatures of the extruder zones are set at 185° C. or lower, which also yields a melt temperature above the melting point of the PP homopolymer, but significantly below the melting point of the PET fiber. In another exemplary embodiment, the barrel temperatures of the extruder zones are set at 215° C. or lower.

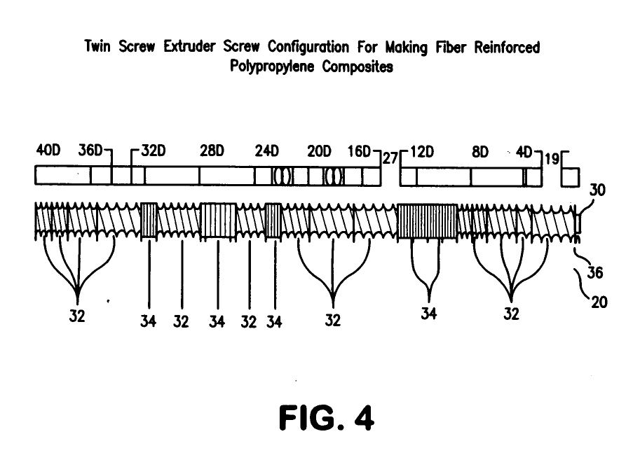

An exemplary schematic of a twin screw type compounding extruder screw configuration for making fiber reinforced polypropylene resin pellets is depicted in FIG. 4. This particular screw design with numerous kneading elements may be needed when feeding continuous fiber from spools to both cut the fiber and disperse the fiber in the polypropylene melt. Such a design with numerous kneading elements may not be needed when feeding pre-cut fiber because the screw does not need to cut the organic fiber. The feed throat 19 allows for the introduction of polypropylene based resin, pre-cut organic fiber, and inorganic filler into a feed zone of the twin screw compounding extruder 20. The inorganic filler and/or chopped fiber may be optionally fed to the extruder 20 at the downstream feed port 27 of FIG. 4. The twin screws 30 of FIG. 4 include an arrangement of interconnected screw sections, including conveying elements 32 and kneading elements 34. The kneading elements 34 function to melt the polypropylene based resin, disperse the cut fiber within the melt, and mix the polypropylene based melt, cut fiber and inorganic filler to form a uniform blend. More particularly, the kneading elements function to disperse the cut fiber and inorganic filler within the PP based melt. A series of interconnected kneading elements 34 is also referred to as a kneading block. U.S. Pat. No. 4,824,256 to Haring, et al., herein incorporated by reference in its entirety, discloses co-rotating twin screw extruders with kneading elements. The first section of kneading elements 34 located downstream from the feed throat is also referred to as the melting zone of the twin screw compounding extruder 20. The conveying elements 32 function to convey the solid components, melt the polypropylene based resin, and convey the melt mixture of polypropylene based polymer, inorganic filler and cut fiber downstream toward the strand die 28 (see FIG. 2) at a positive pressure.

The position of each of the screw sections as expressed in the number of diameters (D) from the start 36 of the extruder screws 30 is also depicted in FIG. 4. The extruder screws in FIG. 4 have a length to diameter ratio of 40/1, and at a position 32D from the start 36 of screws 30, there is positioned a kneading element 34. The particular arrangement of kneading and conveying sections is not limited to that as depicted in FIG. 4, however one or more kneading blocks consisting of an arrangement of interconnected kneading elements 34 may be positioned in the twin screws 30 at a point downstream of where organic fiber and inorganic filler are introduced to the extruder barrel. The twin screws 30 may be of equal screw length or unequal screw length. Other types of mixing sections may also be included in the twin screws 30, including, but not limited to, Maddock mixers, and pin mixers.

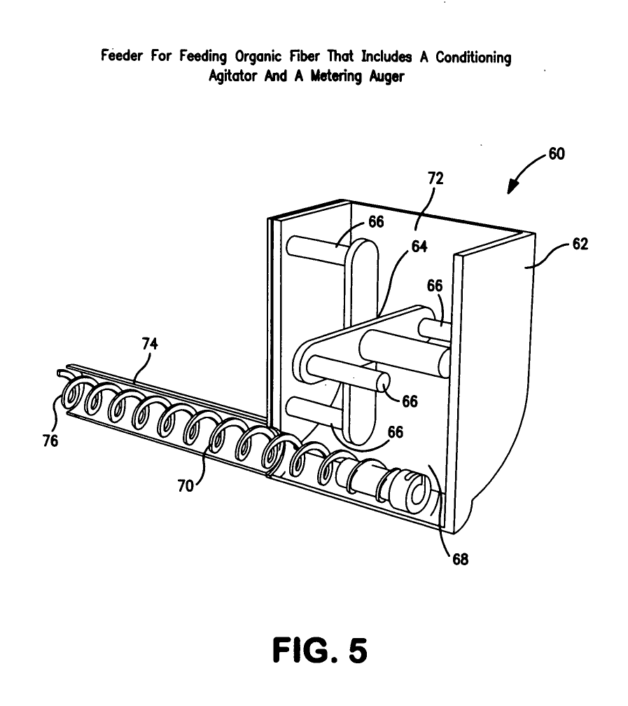

FIG. 5 is an exemplary schematic of a feeder 60 that may be used to meter the pre-cut organic fiber to the compounding extruder (not shown) at either the extruder hopper or a downstream feed port in the extrusion compounder. Referring to FIG. 5, the pre-cut fiber (not shown) is placed in a feeder hopper 62. Within the feed hopper 62 is a single conditioning agitator 64, which includes four arms 66 that protrude from the center axis radially and then bend 90 degrees. The single conditioning agitator prevents the pre-cut fiber from bridging in the throat 68 leading to the spiral type metering auger 70. As shown in FIG. 5, the spiral metering auger 70 does not have a center shaft to allow the conditioned pre-cut fiber from the agitator to fill the void space between the spirals for ease of conveying by the auger 70. Both the conditioning agitator 64 and the metering auger 70 are driven by independent motors and controllers (not shown).

The feed rate of the pre-cut fiber is determined by the efficiency of filling the metering auger 70 with fiber, the size (screw diameter) of the metering auger 70 and the speed in rpms of the metering auger 70. The channels between the spirals of the auger 70 are more effectively filled when the conditioning agitator 64 is used. More particularly, the conditioning agitator 64 may help to minimize or prevent bridging of the cut fiber (not shown) in the throat 68 leading to the auger 70. The speed of the conditioning agitator 64 in rpms must be high enough to prevent fiber clumps from forming, which may lead to bridging in the throat 68. The conditioning agitator 64 may also be optionally vibrated to further prevent the formation of fiber clumps. Alternatively, the side walls 72 of the feeder hopper 62 may be outfitted with a vibrating mechanism (not shown) to facilitate flow of cut fiber down the side walls 72 towards the throat 68 area, and also to increase the bulk density of the cut fiber in the feeder hopper 62. It is also advantageous that the side walls 72 of the feeder hopper be non-parallel and wedge-shaped to also facilitate the movement of fiber down the side walls 72. The spiral type metering auger 70 is housed in a cylindrical housing 74 of larger inside diameter than the outside diameter of the auger 70. The length of the cylindrical housing 74 and the metering auger 70 are not particularly limited, and may be as short as necessary while still maintaining fiber feed rate consistency and accuracy. Cut fiber is gravity fed into the auger 70 at the throat 68 of the feeder hopper 62 and is conveyed out of the auger at the exit end 76 of the cylindrical housing 74. The feeder 60 may operate in a gravimetric loss-in-weight type mode or a volumetric type mode, although the gravimetric mode is advantageous for improved feed rate accuracy. At the exit end 76 of the cylindrical housing 74 may also be advantageously positioned one or more pickers (not shown). A picker is a device that has a rotating cylindrical shaft with metal protrusions (such as pins or spikes) radially emerging around the circumference and length of the shaft. The picker functions to break-up any cut fiber clumps exiting from the feeder 60. In essence, the rotating spikes, pins or protrusions on the shaft break-up or pull apart any fiber clumps exiting the metering auger 70. The picker has a drive motor for adjusting the speed in rpms of the rotating shaft. A controller may be optionally included to control the speed in rpms of the picker via closed loop feedback control to the drive motor. The picker prevents fiber clumps from falling into the compounding extruder at either the extruder hopper or a downstream feed port.

The feeder 60 and picker (not shown) devices described above resolve both issues involved with the feeding of pre-cut fiber. More particularly, the conditioning agitator 64 with optional vibration may help ensure fiber feed rate consistency by helping to prevent bridging in the throat 68 area of the feeder 60. The picker breaks-up any fiber clumps emerging from the metering auger 70 to allow for improved dispersion of the cut fiber through the compounding process.

In another exemplary embodiment (not shown) of a screw type feeder for feeding organic fiber, a metering auger is included, but a conditioning auger/agitator is not provided in the feeder hopper. In this particular embodiment, the feeder hopper is provided with a vibrating means for facilitating the flow of cut fiber down the hopper and into the throat area of the metering auger, and correspondingly helping to prevent bridging of fiber in the throat area. In one non-limiting form, the vibrating means may include one or more metallic plates through which a resonant frequency is periodically or continuously propagated to create the vibration of the one or more plates. The one or more plates may be attached to the surface of or built into the feeder hopper walls to provide the means for vibrating the hopper, which then gets translated from the feeder hopper walls to the organic fiber in the feeder hopper. This particular embodiment is advantageously simpler by eliminating the conditioning auger/agitator and the associated hardware for driving it. The feeder hopper vibration means helps to improve feed rate consistency from the screw type feeder. At the exit end of the metering auger may also be advantageously positioned one or more pickers (not shown) as described above. The picker again functions to break-up any cut fiber clumps exiting from the feeder. The rotating spikes, pins or protrusions on the shaft of the picker break up or pull apart any fiber clumps coming off the metering auger. The picker prevents fiber clumps from falling into the compounding extruder at either the extruder hopper or a downstream feed port.

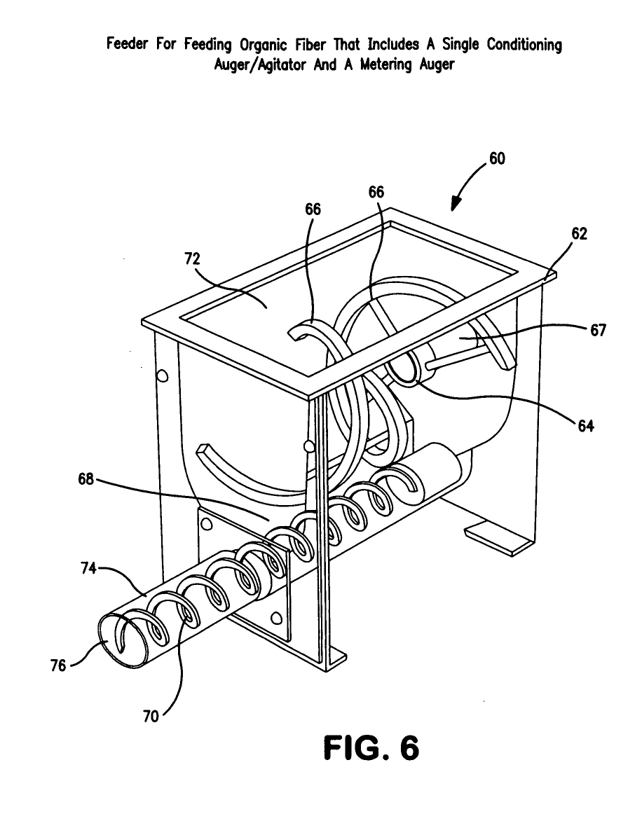

FIG. 6 is another exemplary schematic of a feeder 60 that may be used to meter the pre-cut organic fiber to the compounding extruder (not shown) at either the extruder hopper or a downstream feed port in the extrusion compounder. Referring to FIG. 6, the pre-cut fiber (not shown) is placed in a feeder hopper 62. Within the feed hopper 62 is a single conditioning auger/agitator 64, which includes a spiral shaped auger or mixer blade 66 radiating from the center shaft 67 of the auger/agitator 64. Again the single conditioning auger/agitator 64 prevents the pre-cut fiber from bridging in the throat 68 leading to the spiral type metering auger 70. As shown in FIG. 6, the spiral metering auger 70 does not have a center shaft to allow the conditioned pre-cut fiber from the conditioning auger/agitator 64 to fill the void space between the spirals for ease of conveying by the metering auger 70. Both the conditioning auger/agitator 64 and the metering auger 70 are driven by independent motors and controllers.

The feed rate of the pre-cut fiber is determined by the efficiency of filling the metering auger 70 with fiber and the speed in rpms of the metering auger 70. The channels between the spirals of the auger 70 are more effectively filled when the conditioning auger/agitator 64 is used. More particularly, the conditioning auger/agitator 64 may prevent bridging of the cut fiber (not shown) in the throat 68 leading to the auger 70. The speed of the conditioning auger/agitator 64 in rpms must be high enough to prevent fiber clumps from forming, which may lead to bridging in the throat 68. The conditioning auger/agitator 64 may also be optionally vibrated to further prevent the formation of fiber clumps. Alternatively, the side walls 72 of the feeder hopper 62 may be outfitted with a vibrating mechanism (not shown) to facilitate flow of cut fiber down the side walls 72 towards the throat 68 area and also to increase the bulk density of the cut fiber in the feeder hopper 62. It is also advantageous that the side walls 72 of the feeder hopper be non-parallel and wedge-shaped to also facilitate the movement of fiber down the side walls 72. The metering auger 70 is again housed in a cylindrical housing 74 of larger inside diameter than the outside diameter of the auger 70. The length of the cylindrical housing 74 and the metering auger 70 are not particularly limited, and may be as short as necessary while still maintaining fiber feed rate consistency and accuracy. Cut fiber is gravity fed into the metering auger 70 at the throat 68 of the feeder hopper 62 and is conveyed out of the auger at the exit end 76 of the cylindrical housing 74. The feeder 60 may operate in a gravimetric loss in weight type mode or a volumetric type mode, although the gravimetric mode is advantageous for improved feed rate accuracy. At the exit end 76 of the cylindrical housing 74 may also be advantageously positioned one or more pickers (not shown) as described above. The picker again functions to break-up any cut fiber clumps exiting from the feeder 60. The rotating spikes, pins or protrusions on the shaft of the picker break up or pull apart any fiber clumps coming off the metering auger 70. The picker prevents fiber clumps from falling into the compounding extruder at either the extruder hopper or a downstream feed port.

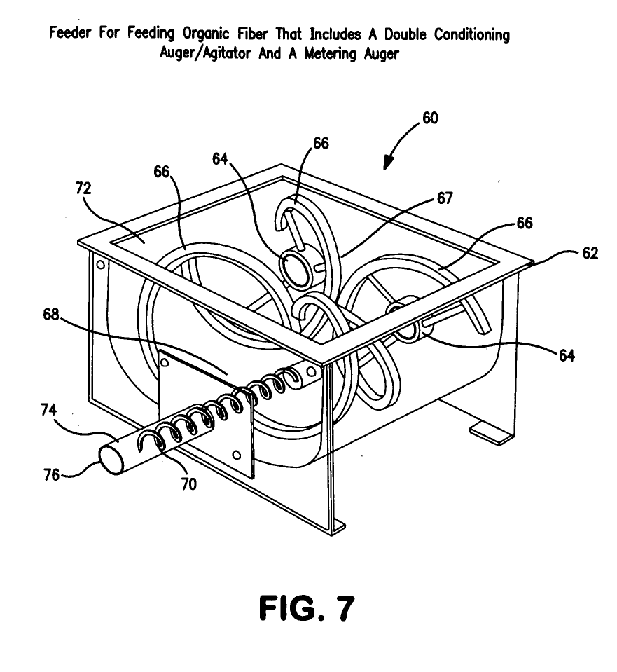

FIG. 7 is still another exemplary schematic of a feeder 60 that may be used to meter the pre-cut organic fiber to the compounding extruder (not shown) at either the extruder hopper or a downstream feed port in the extrusion compounder. Referring to FIG. 7, the feeder 60 is very similar to that of FIG. 6, except that it has two conditioning augers/agitators 64 at the bottom of the feed hopper 62 for breaking up pre-cut fiber clumps and preventing bridging in the throat 68 of the feeder 60. The two conditioning augers/agitators counter-rotate to direct the cut fiber down the center of the feed hopper 62 towards the single spiral metering auger 70. The use of two conditioning augers/agitators 64 is advantageous relative to the single conditioning auger/agitator of FIG. 6 in providing cut fiber to the spiral metering auger 70 and further preventing formation of fiber clumps within the feeder hopper 62. Hence, the two conditioning augers/agitators 64 may be advantageous relative to the single conditioning auger/agitator in preventing bridging in the throat area 68 leading to the metering auger 70. Again at the exit end 76 of the cylindrical housing 74 may also be advantageously positioned one or more pickers (not shown) as described above. The picker functions to break-up any cut fiber clumps exiting from the feeder 60. The rotating spikes, pins or protrusions on the shaft break up or pull apart any fiber clumps coming off the metering auger 70. The picker prevents fiber clumps from falling into the compounding extruder at either the extruder hopper or a downstream feed port.

The auger type fiber feeder systems depicted in FIGS. 5, 6 and 7 may be varied within deviating from the scope of the disclosure herein. For example, the number and type of mixing blades used on the conditioning auger/agitator may take on many different forms (paddles, spirals, etc.) and configurations. The number of conditioning augers/agitators in the feeder hopper may be one, or two, or three, or more. Generally, two or more conditioning augers/agitators may be advantageous in eliminating bridging of the cut fiber at the bottom of the feeder hopper. In addition, the number of metering augers 70 may be two as opposed to one. Alternatively, the number of metering augers 70 may be three or more. In addition, the one or more metering augers 70 may have a center shaft and variations on the design of the spirals for metering the pre-cut fiber. A metering auger 70 with a shaft may be less efficient in metering rate, but this may be compensated for by a larger metering auger diameter and number of metering augers. The size of the auger type fiber feeder system will depend on the desired feed rate of the cut fiber. Cut fiber feed rates using the feeder 60 may be controlled from less than 1 kilogram per hour to up to 500 kilograms per hour depending upon the size of the compounding extruder and the fiber loading in the fiber reinforced polypropylene compositions. Generally, the size of the feeder hopper 62, the one or more conditioning augers/agitators 64 and the one or more metering augers 70 are increased as the desired cut fiber output rate is increased.

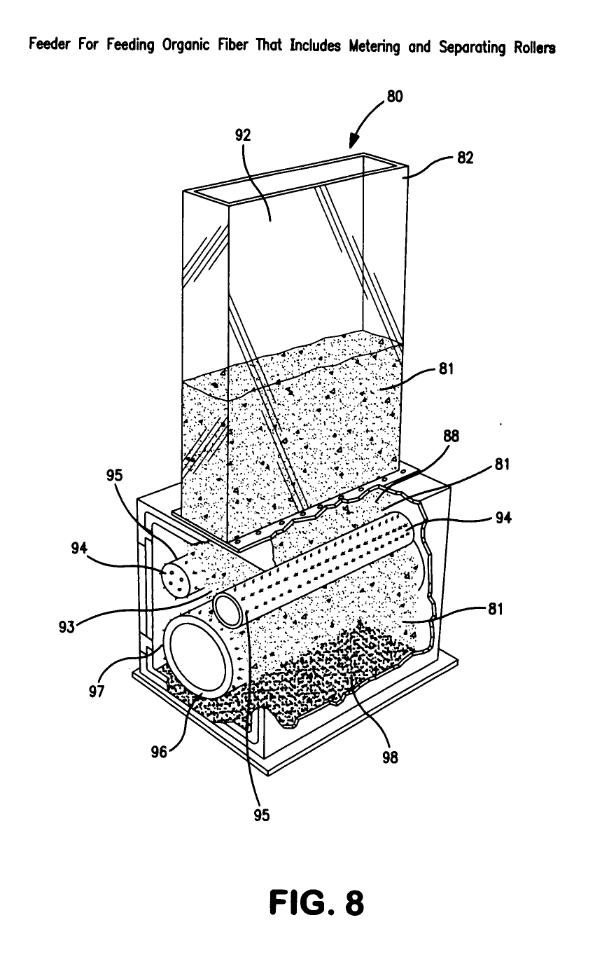

FIG. 8 is another exemplary schematic of a feeder 80 utilizing metering and separating rollers as opposed to conditioning agitators and metering augers to feed the pre-cut organic fiber 81 to the compounding extruder (not shown) at either the extruder hopper or a downstream feed port in the extrusion compounder. The feeder of FIG. 8 including metering and separating rollers may also be referred to as a fiber feeder 80. Referring to FIG. 8, the pre-cut fiber 81 is placed in a feeder hopper 82. A conditioning agitator is not depicted and is not required to prevent bridging of the pre-cut fiber in the throat 88 area. Optionally a conditioning auger/agitator may be included in feeder hopper and may be any of the types previously presented and discussed in FIGS. 5, 6 and 7. Advantageously, the side walls 92 of the feeder hopper 82 may be outfitted with a vibrating mechanism (not shown) to facilitate flow of cut fiber down the side walls 92 towards the throat 88 area and also to increase the bulk density of the pre-cut fiber in the feeder hopper 82. It is also advantageous that the side walls 92 of the feeder hopper be non-parallel and wedge-shaped to further facilitate the movement of fiber down the side walls 92 toward the metering rollers 94 and separating rollers 96. The two metering rollers 94 slowly rotate in a counter rotating direction to secure the fiber mass and to meter the cut fiber 81 into the gap 93 between the two metering rollers 94.

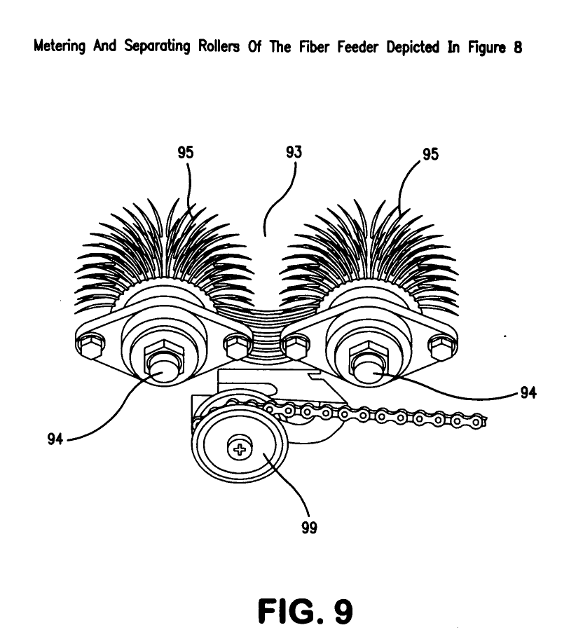

Referring to FIG. 9, the two metering rollers 94 may be linked by a gear and pulley combination 99 and driven by a common motor (not shown), and hence controlled to the same speed in revolutions per minute by a speed controller (not shown). The metering rollers 94 have pins 95 or other suitable protrusions (spikes, etc.) on the surface that extend out radially around the circumference of the rollers for precisely metering the cut fiber flow rate to the gap 93 between the two metering rollers 94. The pins 95 are generally made of a metallic material, for example, but not limited to, stainless steel, mild steel and aluminum.

Referring again to FIG. 8, the higher the rpms of the metering rollers 94, the greater will be the feed rate of the cut fiber 81 to the subsequent separating roller 96. The separating roller 96 also has pins 97 or other protrusions (spikes) on the surface that extend out radially around the circumference of the roller to produce a flow of individual cut fibers 81 that are subsequently gravity conveyed out of the feeder 80 exit opening 98 to the compounding extruder. The separating roller 96 rotates at much higher speed relative to the metering rollers 94, and hence is driven by a separate motor and controller combination (not shown). In one form, the metering rollers rotate at between 1 and 20 rpms, or between 2 and 10 rpms, or between 4 and 8 rpms, and the separating roller rotates at greater than 50 rpms, or greater than 100 rpms, or greater than 200 rpms. The fiber feeder 80 may operate in a gravimetric loss in weight type mode or a volumetric type mode, although the gravimetric mode is advantageous for improved feed rate accuracy.

The fiber feeder 80 of FIGS. 8 and 9 results in a uniform and controlled flow rate of individual cut fibers 81, as opposed to a non-uniform flow rate of fiber clumps, to the compounding extruder. This alleviates the need for a picker at the exit 98 of the feeder 80 to break up fiber clumps. In one alternative form, the fiber feeder 80 may include two separating rollers rotating in a counter rotating direction. The fiber feeder 80 of FIGS. 8 and 9 separates the fiber entering the compounding extruder, stabilizes the mass flow rate of fiber, and precisely meters fiber flow rate. These features advantageously result in little to no fiber degradation during processing. The capacity of the fiber feeder 80 is determined by the diameter of the metering and conditioning rollers, the width of the rollers, and the speed at which they rotate. Cut fiber feed rates using the fiber feeder 80 may be controlled from less than 1 kilogram per hour to up to 500 kilograms per hour depending upon the size of the compounding extruder and the fiber loading in the fiber reinforced polypropylene compositions. In addition, the size of the feeder hopper 82 is increased for higher desired cut fiber output rates.

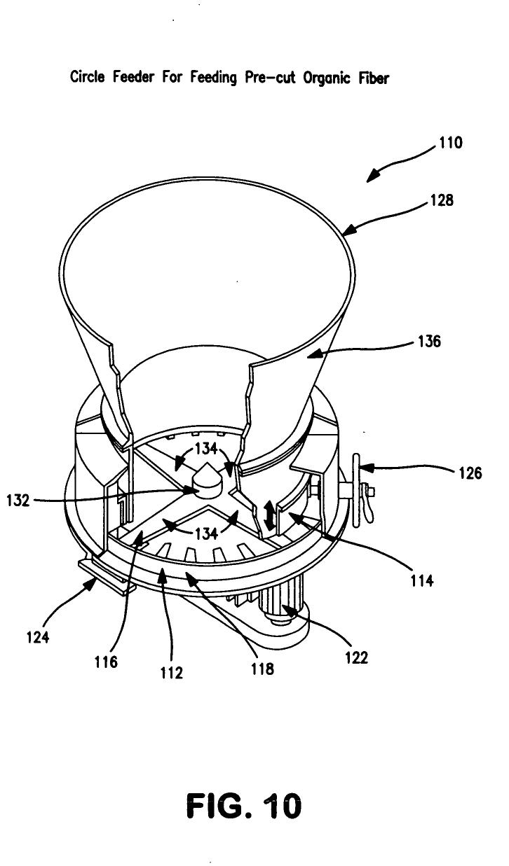

FIG. 10 is another exemplary schematic of a circle feeder 110 to feed the pre-cut organic fiber (not shown) to the compounding extruder (not shown) at either the extruder hopper or a downstream feed port. U.S. Pat. No. 6,860,410 discloses the circle feeder and is herein incorporated by reference in its entirety. The circle feeder 110 of FIG. 10 includes a stationary bottom plate or panel 112, a flow adjusting ring (weir) 114, central rotating vanes 116, peripheral rotating vanes encased by a cylindrical ring 118, a drive shaft/speed reducer/motor 122, a discharge port 124 and a flow adjusting handle 126. A feeder hopper 128 is mounted on top of the circle feeder 110. The central and peripheral rotating vanes 116, 118 are attached. The drive shaft 132 runs up through the center of the bottom plate 112, and is attached to the central rotary vanes 116 which consist of four evenly distributed flat blades 134. Inside the flow adjusting ring 114, cut fiber pressure is imposed. Because of the natural collapse of the cut fiber being fed and the slow rotation of the central vanes 116, the cut fiber flows out to the periphery where no fiber pressure is exerted. At the periphery, the rotation of the peripheral vanes 112 carries the cut fiber to the discharge port 124. The two variables that control the circle feeder 110 discharge rate are shaft rotation and the height of the flow adjusting ring (weir) 114. The rotation of the central vanes 116 is controlled by a variable speed motor 122 and controller (not shown).

In regard to the feeding of pre-cut organic fiber, the circle feeder depicted in FIG. 10 provides one or more of the following non-limiting advantages. The large opening under the feeder hopper 128 breaks the critical arch of cut fiber, which prevents bridging of cut fiber. The slow rotating vanes 116 move the cut fiber radially from the center to the outlet ensuring “first in-first out” mass flow through the feeder 110. A wide range of cut fiber discharge rates are possible by varying motor 122 speed and the height of the flow adjusting ring 114. In addition, the larger diameter opening between the feeder hopper 128 and the feeder itself allows for large feeder hopper capacity to accommodate high cut-fiber discharge rates. The discharge port flange 124 of the circle feeder 110 is then coupled to the compounding extruder hopper inlet port or a downstream feed or injection port for accurately and continuously feeding cut fiber into the polypropylene based resin.

A conditioning auger/agitator is not depicted and is not required to prevent bridging in the feeder hopper 128 of the circle feeder 110. Optionally the side walls 136 of the feeder hopper 128 may be outfitted with a means for vibrating (not shown) the hopper walls to further facilitate flow of cut fiber down the side walls 136 and also to increase the bulk density of the pre-cut fiber in the feeder hopper 128. It is also advantageous that the side walls 136 of the feeder hopper 128 be non-parallel and wedge-shaped to further facilitate the movement of fiber downward.

At the exit of the discharge port flange 124 of the circle feeder 110 may be optionally positioned one or more pickers (not shown) as described above. The picker again functions to break-up any cut fiber clumps exiting from the circle feeder 110. The rotating spikes, pins or protrusions on the shaft of the picker break up or pull apart any fiber clumps coming out of the discharge port flange 124. The picker prevents fiber clumps from falling into the compounding extruder at either the extruder hopper or a downstream feed port.

The advantages of the feeder systems for cut fiber disclosed in FIGS. 5 to 10 include, but are not limited to, one or more of the following: avoidance of fiber bridging in the throat or hopper of the feeder, higher fiber throughput rate achievable than when feeding fiber in continuous form from spools, improved feed rate consistency of fiber, avoidance of fiber clumps being fed to the compounding extruder, the ability to feed individual fibers to the compounding extruder, decreased fiber degradation during compounding, greater stability of fiber mass flow rate, and improved dispersion of fibers in the fiber reinforced polypropylene composite.

Referring once again to FIG. 2, the uniformly mixed PET fiber reinforced polypropylene composite melt comprising polypropylene based polymer 10, inorganic filler 12, and pre-cut fiber 14 is metered by the extruder screws to a strand die 28 for forming one or more continuous strands 40 of fiber reinforced polypropylene composite melt. The one or more continuous strands 40 are then passed into water bath 42 for cooling them below the melting point of the fiber reinforced polypropylene composite melt to form a solid fiber reinforced polypropylene composite strands 44. The water bath 42 is typically cooled and controlled to a constant temperature much below the melting point of the polypropylene based polymer. The solid fiber reinforced polypropylene composite strands 44 are then passed into a pelletizer or pelletizing unit 46 to cut them into fiber reinforced polypropylene composite resin 48 into fiber reinforced polypropylene based resin pellets. Non-limiting exemplary pelletizers include underwater type pelletizers and strand type pelletizers. In one advantageous process form, a strand pelletizer is used to cut the fiber reinforced polypropylene composite into longer resin pellets than may be formed with an underwater type pelletizer. Generally, the number of cutting blades and the speed of the cutting blades in the pelletizer 46 may be used to control the resulting resin pellet length produced. The fiber reinforced polypropylene composite resin pellets 48 may then be accumulated in boxes 50, barrels, or alternatively conveyed to silos for storage.

The fiber reinforced polypropylene composites disclosed herein may be formed into resin pellets using the extrusion compounding and pelletizing processes exemplified in FIGS. 2, 3 and 4. The resin pellets produced in the pelletizer 46 of FIG. 2 may have a length of from 1.0 mm to 25.4 mm. Pellet length is measured using a ruler or other linear measuring device. The lower limit of the resin pellet length may be 1.0 mm, or 2.0 mm, or 3.2 mm, or 4.8 mm, or 6.4 mm, or 8.0 mm, or 9.5 mm. The upper limit of the resin pellet length may be 8.0 mm, or 9.5 mm, or 11.1 mm or 12.7 mm, or 13.9 mm, or 15.0 mm, or 17.0 mm, or 19.1 mm, or 21.0 mm, or 23.0 mm, or 25.4 mm. In one particular embodiment, fiber reinforced polypropylene resin pellets may have a pellet length from 3.2 to 12.7 mm, or 6.4 to 9.5 mm. In another particular embodiment, fiber reinforced polypropylene resin pellets may have a pellet length from 3.2 to 12.7 mm, or 3.2 to 19.1 mm, or 3.2 to 9.5 mm, or 6.4 to 9.5 mm, or 9.5 to 19.1 mm or 9.5 to 12.7 mm. The optimum resin pellet length range for impact resistance may depend on such exemplary factors as organic fiber type, input organic fiber diameter, organic fiber loading level, input organic fiber length within the fiber reinforced polypropylene melt, method of feeding the organic fiber into the extrusion compounding process (as a chopped or staple fiber or as continuous strands being unwound from spools). In particular, the method of feeding the PET fiber into the extrusion compounding process as a chopped/staple fiber or as continuous strands being unwound from spools may impact the resultant impact resistance of articles molded from the resin pellets.

Articles of the present disclosure may be alternatively made by directly forming the polypropylene resin and additives needed to form fiber-reinforced polypropylene composition into an article or part via a combined in-line compounding and molding process. This is referred to as an in-line compounding and molding process and consists of the coupling of a compounding process and a molding process. Using in-line compounding and molding, materials comprising reinforced polypropylene compositions may be compounded and molded all in one step. The polymer, fiber and talc filler may be introduced into an extruder attached directly to an injection or compression molder. Instead of creating pellets of compounded material in a separate compounding process, which are later molded, the molten compound is conveyed directly to the mold from the compounding process. In one exemplary embodiment of the in-line compounding and molding process, between the compounding process and the molding process may be a melt reservoir for holding surge melt from the continuous compounding process before it enters into the discontinuous molding process. In another exemplary embodiment of the in-line compounding and molding process, between the compounding process and the molding process is a flow channel without a melt reservoir that leads to two or more molding units. Further details of the method of making fiber reinforced polypropylene articles using the in-line compounding and molding process, and the benefits provided thereto are included in U.S. patent application Ser. No. 11/435,578, herein incorporated by reference in its entirety.

### Fiber Reinforced Polypropylene Compositions:

The fiber reinforced polypropylene composite resin pellets of the present disclosure simultaneously have desirable stiffness, as measured by having a flexural modulus of at least 300,000 psi (2.07 GPa), and toughness, as measured by exhibiting ductility during instrumented impact testing. In addition, fiber reinforced polypropylene composite resin pellets of the present disclosure with particular pellet lengths may yield articles with drop dart impact resistance values exceeding 5.0, or 6.0, or 7.0, or 8.0, or 9.0, or 10.0, or 11.0, or 12.0, or 13.0 newton meter. In a particular embodiment, the fiber reinforced polypropylene resin pellets after molding may yield an article having a flexural modulus of at least 350,000 psi (2.41 GPa), or at least 370,000 psi (2.55 GPa), or at least 390,000 psi (2.69 GPa), or at least 400,000 psi (2.76 GPa), or at least 450,000 psi (3.10 GPa). Still more particularly, the fiber reinforced polypropylene resin pellets after molding may yield an article have a flexural modulus of at least 600,000 psi (4.14 GPa), or at least 800,000 psi (5.52 GPa). It is also believed that having a weak interface between the polypropylene matrix and the organic fiber contributes to fiber pullout; and, therefore, may enhance toughness. Thus, there is no need to add modified polypropylenes to enhance bonding between the fiber and the polypropylene matrix, although the use of modified polypropylene may be advantageous to enhance the bonding between a filler, such as talc or wollastonite and the matrix polymer. In addition, in one embodiment, there is no need to add lubricant to weaken the interface between the polypropylene and the fiber to further enhance fiber pullout. Some embodiments also display no splintering during instrumented dart impact testing, which yield a further advantage of not subjecting a person in close proximity to the impact to potentially harmful splintered fragments. This characteristic is advantageous in automotive applications.

Compositions of the present disclosure generally include at least 25 wt %, based on the total weight of the composition, of polypropylene based polymer as the matrix resin. In a particular embodiment, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 60 wt %, or 75 wt %, or 80 wt %, based on the total weight of the composition. In another embodiment, the polypropylene is present in an amount of at least 25 wt %.

The polypropylene based resin used as the matrix resin is not particularly restricted and is generally selected from propylene homopolymers, propylene-ethylene random copolymers, propylene-butene-1 random copolymers, propylene-hexene-1 random copolymers, propylene-octene-1 random copolymers, other propylene-α-olefin random copolymers, propylene block copolymers, propylene impact copolymers, ethylene-propylene-butene-1 terpolymers and combinations thereof. In a particular embodiment, the polypropylene is a propylene homopolymer. In another particular embodiment, the polypropylene is a propylene impact copolymer comprising from 78 to 95 wt % homopolypropylene and from 5 to 22 wt % ethylene-propylene rubber, based on the total weight of the impact copolymer. In a particular aspect of this embodiment, the propylene impact copolymer comprises from 90 to 95 wt % homopolypropylene and from 5 to 10 wt % ethylene-propylene rubber, based on the total weight of the impact copolymer.

The polypropylene base resin of the matrix resin may have a melt flow rate of from 20 to 1500 g/10 min. In a particular embodiment, the melt flow rate of the polypropylene matrix resin is greater 100 g/10 min, and still more particularly greater than or equal to 400 g/10 min. In yet another embodiment, the melt flow rate of the polypropylene matrix resin is less than or equal to 2000 g/10 min. The higher melt flow rate permits for improvements in processability, throughput rates, and higher loading levels of organic fiber and inorganic filler without negatively impacting flexural modulus and impact resistance.

In a particular embodiment, the matrix polypropylene may contain less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular embodiment, the matrix polypropylene does not contain a modifier. In still yet another particular embodiment, the polypropylene based polymer further includes from 0.1 wt % to less than 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment. The amount of additive, if present, in the polypropylene matrix is generally from 0.5 wt % or 2.5 wt % to 7.5 wt % or 10 wt %, based on the total weight of the matrix. Diffusion of additive(s) during processing may cause a portion of the additive(s) to be present in the fiber.

The polypropylene matrix resin of the present disclosure is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the disclosure is not limited to any particular catalyst for making the polypropylene, and may, for example, include Ziegler-Natta or metallocene catalysts.

The fiber reinforced polypropylene resin pellets disclosed herein generally include at least 5 wt %, based on the total weight of the composition, of an organic synthetic polymer-based fiber. In a particular embodiment, the fiber is present in an amount of at least 5 wt %, or at least 10 wt %, or at least 15 wt %, or at least 20 wt %, or in an amount within the range having a lower limit of 5 wt %, 10 wt %, or 15 wt %, or 20 wt %, or 25 wt %, and an upper limit of 25 wt %, or 30 wt %, or 40 wt %, or 50 wt %, or 55 wt %, or 60 wt %, or 70 wt %, based on the total weight of the composition. In another embodiment, the organic fiber is present in an amount of at least 10 wt % and up to 40 wt %. In yet another embodiment, organic fiber is present in an amount of at least 20 wt % and up to 40 wt %. In order to improve the impact resistance, organic fibers are also referred to as reinforcing fibers and are incorporated into the polypropylene based polymer matrix.

The synthetic polymer used as the fiber is not particularly restricted and is generally selected from the group consisting of polyalkylene terephthalates, polyalkylene naphthalates, polyamides, polyolefins, polyacrylonitrile, and combinations thereof. In a particular embodiment, the fiber comprises a polymer selected from the group consisting of polyethylene terephthalate (PET), polybutylene terephthalate, polyamide and acrylic. In another embodiment, PET fiber is advantageous in yielding PET fiber reinforced polypropylene resin pellets with drop dart impact resistance values of at least 5.0 newton meter and exhibiting no splintering upon drop dart impact testing over a range of pellet lengths of 3.2 to 25.4 mm. In another particular embodiment, PET fiber is advantageous in yielding PET fiber reinforced polypropylene resin pellets with drop dart impact resistance values of at least 5.3 newton meter over a range of pellet lengths ranging from 3.2 to 12.7 mm. In yet another particular embodiment, PET fiber in the form of continuous fiber fed to the compounding extruder is advantageous in yielding PET fiber reinforced polypropylene resin pellets with drop dart impact resistance values of at least 7.9 newton meter over a range of pellet lengths ranging from 6.4 to 9.5 mm. In still yet another particular embodiment, PET fiber in the form of 6.4 mm long chopped (pre-cut) fiber is advantageous in yielding PET fiber reinforced polypropylene resin pellets with drop dart impact resistance values of at least 6.4 newton meter over a range of pellet lengths ranging from 9.5 to 12.7 mm.

In one embodiment, the fiber is a single component fiber. In another embodiment, the fiber is a multicomponent fiber wherein the fiber is formed from a process wherein at least two polymers are extruded from separate extruders and meltblown or spun together to form one fiber. In a particular aspect of this embodiment, the polymers used in the multicomponent fiber are substantially the same. In another particular aspect of this embodiment, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the organic fibers of the present disclosure are not particularly restricted. The length of the cut fiber within the meaning of this disclosure is with respect to the input length of the pre-cut or chopped PET fiber being fed to the compounding extruder or other mixing apparatus. This is also referred to within the detailed description and the claims of the present disclosure as the “input chopped fiber length” or the “input cut fiber length.” The length of the cut or chopped fiber referred to within the detailed description and the claims is not with respect to the length of the fiber within the pellets after compounding. It is understood that during the extrusion compounding process, the input chopped or cut fiber may undergo further length reduction through the process. In a particular embodiment, the input cut or chopped fibers may have a length of 6.4 mm, or a length within the range of 3.2 to 25.4 mm, or more particularly a length within the range of 4.8 to 12.7 mm. In another embodiment, the input cut fibers may have a length of 3.2 to 19.1 mm, or 6.4 to 12.7 mm. In another embodiment, the input cut fiber length may be 3.2 mm, or 6.4 mm, or 12.7 mm, or 19.1 mm, or 25.4 mm.

The diameter or denier of the organic fiber within the meaning of this disclosure is also with respect to the input diameter or denier of the organic fiber being fed to the compounding extruder or other mixing apparatus. Denier is defined as grams of fiber per 9000 meters of fiber length. This is also referred to within the detailed description and the claims of the present disclosure as the “input fiber denier” or the “input fiber diameter.” The diameter or denier of the fiber referred to within the detailed description and the claims is not with respect to the diameter of the fiber within the pellets after compounding. It is understood that during the extrusion compounding process, the input fiber may undergo a change in denier or diameter due to shrinkage or expansion through the process. Denier may be related to fiber diameter for a given fiber type (fiber density).

The diameter of the organic fiber may be within the range having a lower limit of 5 μm and an upper limit of 100 μm. In a particular embodiment, the PET fibers have a diameter of from 25 to 35 μm (6 to 12 denier), or more particularly a diameter of from 25 to 30 μm (6 to 9 denier). In another embodiment, the input PET fiber may range from 5 to 15 denier. In another embodiment, the input PET fiber diameter ranges from 15 to 35 μm. In yet another embodiment, the PET fiber diameter is less than 15 microns. In another embodiment, the PET fiber denier is less than 5, or less than 4, or less than 3.2, or less than 2. In still yet another embodiment, the PET fiber denier is 3.1 (also referred to herein as low denier PET fiber). As the PET fiber denier or diameter decreases, generally increased loadings are needed in the PP/PET composite to maintain impact resistance constant.

The organic fiber may further contain additives commonly known in the art. For example, the organic fiber may include additives, such as dispersant, lubricant, flame-retardant, antioxidant, antistatic agent, light stabilizer, ultraviolet light absorber, carbon black, nucleating agent, plasticizer, and coloring agent such as dye or pigment.

The organic fiber used to make the compositions of the present disclosure is not limited by any particular fiber form. For example, the organic fiber may be in the form of continuous filament yarn, partially oriented yarn, or staple fiber. In another embodiment, the fiber may be a continuous multifilament fiber or a continuous monofilament fiber.

In another embodiment of the fiber reinforced polypropylene resin pellets disclosed herein, the fiber reinforced polypropylene compositions further include from 0.01 to 0.2 wt %, or more particularly from 0.05 to 0.1 wt % lubricant, based on the total weight of the composition. Suitable lubricants include, but are not limited to, silicon oil, silicon gum, fatty amide, paraffin oil, paraffin wax, ester oil, and combinations thereof. Lubricant incorporation may assist with the pull-out of organic fiber from the polypropylene based matrix polymer to further improve impact resistance.

In another exemplary embodiment of the present disclosure, the fiber reinforced polypropylene resin pellets may be made cloth-like in terms of appearance, feel, or a combination thereof. Cloth-like appearance or look is defined as having a uniform short fiber type of surface appearance. Cloth-like feel is defined as having a textured surface or fabric type feel. The incorporation of the colorant fiber into the fiber reinforced polypropylene composition results in a cloth-like appearance. When the fiber reinforced polypropylene composition is processed through a mold with a textured surface, a cloth-like feel is also imparted to the surface of the resulting molded part.

Cloth-like fiber reinforced polypropylene resin pellets of the present disclosure generally include from 0.1 to 2.5 wt %, based on the total weight of the composition, of a colorant fiber. Still more advantageously, the colorant fiber is present from 0.5 to 1.5 wt %, based on the total weight of the composition. Even still more advantageously, the colorant fiber is present at less than 1.0 wt %, based on the total weight of the composition.

The colorant fiber type is not particularly restricted and is generally selected from the group consisting of cellulosic fiber, acrylic fiber, nylon fiber or polyester type fiber. Polyester type fibers include, but are not limited to, polyethylene terephlalate, polybutylene terephalate, and polyethylene naphthalate. Polyamide type fibers include, but are not limited to, nylon 6, nylon 6,6, nylon 4,6 and nylon 6,12. In a particular embodiment, the colorant fiber is cellulosic fiber, also commonly referred to as rayon. In another particular embodiment, the colorant fiber is a nylon type fiber.

The colorant fiber used to make the fiber reinforced polypropylene resin pellets disclosed herein is not limited by any particular fiber form prior to being chopped for incorporation into the fiber reinforced polypropylene composition. For example, the colorant fiber may be in the form of continuous filament yarn, partially oriented yarn, or staple fiber. In another embodiment, the colorant fiber may be a continuous multifilament fiber or a continuous monofilament fiber.

The length and diameter of the colorant fiber may be varied to alter the cloth-like appearance in the molded article. The length and diameter of the colorant fiber of the present disclosure is not particularly restricted. In a particular embodiment, the input colorant fibers to the compounding process have a length of less than 6.4 mm, or advantageously a length of between 0.8 to 3.2 mm. In another particular embodiment, the diameter of the input colorant fibers to the compounding process is within the range having a lower limit of 10 μm and an upper limit of 100 μm.

The colorant fiber is colored with a coloring agent, which comprises either inorganic pigments, organic dyes or a combination thereof. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Exemplary pigments and dyes incorporated into the colorant fiber include, but are not limited to, phthalocyanine, azo, condensed azo, azo lake, anthraquinone, perylene/perinone, indigo/thioindigo, isoindolinone, azomethineazo, dioxazine, quinacridone, aniline black, triphenylmethane, carbon black, titanium oxide, iron oxide, iron hydroxide, chrome oxide, spinel-form calcination type, chromic acid, talc, chrome vermilion, iron blue, aluminum powder and bronze powder pigments. These pigments may be provided in any form or may be subjected in advance to various dispersion treatments in a manner known per se in the art. Depending on the material to be colored, the coloring agent can be added with one or more of various additives such as organic solvents, resins, flame retardants, antioxidants, ultraviolet absorbers, plasticizers and surfactants.

The base fiber reinforced polypropylene base composite material that the colorant fiber is incorporated into may also be colored using the inorganic pigments, organic dyes or combinations thereof. Exemplary pigments and dyes for the base fiber reinforced polypropylene composite material may be of the same types as indicated in the preceding paragraph for the colorant fiber. Typically the base fiber reinforced polypropylene composite material is made of a different color or a different shade of color than the colorant fiber, such as to create a cloth-like appearance upon uniformly dispersing the short colorant fibers in the colored base fiber reinforced polypropylene composite material. In one particular exemplary embodiment, the base fiber reinforced polypropylene composite material is light grey in color and the colorant fiber is dark grey or blue in color to create a cloth-like look from the addition of the short colorant fiber uniformly dispersed through the base fiber reinforced polypropylene composite material.

The colorant fiber in the form of chopped fiber may be incorporated directly into the base fiber reinforced polypropylene composite material via the twin screw or single screw extrusion compounding process, or may be incorporated as part of a masterbatch resin to further facilitate the dispersion of the colorant fiber within the fiber reinforced polypropylene composite base material. When the colorant fiber is incorporated as part of a masterbatch resins, exemplary carrier resins include, but are not limited to, polypropylene homopolymer, ethylene-propylene copolymer, ethylene-propylene-butene-1 terpolymer, propylene-butene-1 copolymer, low density polyethylene, high density polyethylene, and linear low density polyethylene. In one exemplary embodiment, the colorant fiber is incorporated into the carrier resin at less than 25 wt %. The colorant fiber masterbatch is then incorporated into the fiber reinforced polypropylene composite base material at a loading of from 1 wt % to 10 wt %, or from 2 to 6 wt %. In a particularly advantageous embodiment, the colorant fiber masterbatch is added at 4 wt % based on the total weight of the composition. In another exemplary embodiment, a masterbatch of either black rayon or black nylon type fibers in linear low density polyethylene carrier resin is incorporated at a loading of 4 wt % in the fiber reinforced polypropylene composite base material.

The colorant fiber or colorant fiber masterbatch may be fed to the twin screw or single screw extrusion compounding process with a gravimetric feeder at either the feed hopper or at a downstream feed port in the barrel of the twin screw or single screw extruder. Kneading and mixing elements are incorporated into the twin screw or single screw extruder screw design downstream of the colorant fiber or colorant fiber masterbatch injection point, such as to uniformly disperse the colorant fiber within the cloth-like fiber reinforced polypropylene composite material.

Compositions of the present disclosure optionally include inorganic filler in an amount of at least 1 wt %, or at least 5 wt %, or at least 10 wt %, or in an amount within the range having a lower limit of 0 wt %, or 1 wt %, or 5 wt %, or 10 wt %, or 15 wt %, and an upper limit of 25 wt %, or 30 wt %, or 35 wt %, or 40 wt %, or 50 wt %, or 60 wt %, based on the total weight of the composition. In yet another embodiment, the inorganic filler may be included in the polypropylene fiber composite in the range of from 10 wt % to 60 wt %. In a particular embodiment, the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof. The talc may have a size of from 1 to 100 microns. In one particular embodiment, at a high talc loading of up to 60 wt %, the polypropylene fiber composite exhibited a flexural modulus of at least 750,000 psi and no splintering during instrumented impact testing (15 mph, −29° C., 25 lbs). In another particular embodiment, at a low talc loading of as low as 10 wt %, the polypropylene fiber composite exhibited a flexural modulus of at least 325,000 psi and no splintering during instrumented impact testing (15 mph, −29° C., 25 lbs). In addition, wollastonite loadings of from 10 wt % to 60 wt % in the polypropylene fiber composite yielded an outstanding combination of impact resistance and stiffness.

In another particular embodiment, a fiber reinforced polypropylene composite resin pellets including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of 140 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively.

In one exemplary embodiment where ¼″ (6.4 mm in length) chopped PET fiber is fed via a feeder into a twin screw or single screw extrusion compounding extruder hopper, the PET reinforced polypropylene resin pellets may range from 3.2 to 12.7 mm in length, and more advantageously from 9.5 to 12.7 mm in length to yield drop dart impact resistance values of at least 6.4 newton meter.

### Applications of Fiber Reinforced Polypropylene Composites:

The fiber reinforced polypropylene composite resin pellets disclosed herein are advantageously molded into articles. Articles made from the fiber-reinforced polypropylene composite resin pellets described herein include, but are not limited to, automotive parts, household appliances, and boat hulls. Automotive parts include both interior and exterior automobile parts. Cloth-like fiber reinforced polypropylene articles are particularly suitable for interior automotive parts because of the unique combination of toughness, stiffness and aesthetics. More particularly, the non-splintering nature of the failure mode during instrumented impact testing, and the cloth-like look make the cloth-like fiber reinforced polypropylene composites disclosed herein are suited for interior automotive parts, and for interior trim cover panels. Exemplary, but not limiting, interior trim cover panels include steering wheel covers, head liner panels, dashboard panels, interior door trim panels, pillar trim cover panels, and under-dashboard panels. Pillar trim cover panels include a front pillar trim cover panel, a center pillar trim cover panel, and a quarter pillar trim cover panel. Other interior automotive parts include package trays, and seat backs. Articles made from the polypropylene compositions described herein are also suitable for exterior automotive parts, including, but not limited to, bumpers, front end modules, aesthetic trim parts, body panels, under body parts, under hood parts, door cores, and other structural parts of the automobile.

Articles molded from the fiber reinforced polypropylene composite resin pellets disclosed herein provide one or more of the following non-limiting exemplary advantages: an advantageous combination of toughness, stiffness, and aesthetics, improved instrumented impact resistance, improved flexural modulus, improved splinter or shatter resistance during instrumented impact testing, fiber pull out during instrumented impact testing without the need for lubricant additives, ductile (non-splintering) failure mode during instrumented impact testing as opposed to brittle (splintering), a higher heat distortion temperature compared to rubber modified polypropylene, improved part surface appearance from lower inorganic filler loadings, lower part density from lower inorganic filler loadings, a lower flow and cross flow coefficient of linear thermal expansion compared to rubber modified polypropylene, the ability to accurately feed organic reinforcing fiber in a pre-cut form into a compounding extruder, reduced production costs and reduced raw material costs, improved part surface appearance, the ability to produce polypropylene fiber composites exhibiting a cloth-like look and/or feel, uniform dispersion of the organic reinforcing fiber and colorant fiber in the composite pellets, improved drop dart impact resistance through tight control of fiber reinforced polypropylene resin pellet length, improved impact resistance through the feeding of chopped fiber as opposed to continuous fiber via spools into the extrusion compounding process, and retention of impact resistance, ductile failure mode and stiffness after the incorporation of colorant with colorant fiber.

The following examples illustrate the present disclosure and the advantages thereto without limiting the scope thereof.

### Test Methods

Fiber reinforced polypropylene compositions described herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., 25 lbs) is defined as no splintering of the sample.

Drop dart impact test data was generated for injected mold samples produced from the PET fiber reinforced polypropylene resin pellets described herein using ASTM test method D3763 and reported in drop dart impact energy values of newton meter.

Impact resistance as described herein is measured by the total energy in newton meter to shatter an article molded from the fiber reinforced polypropylene resin pellets. Drop dart impact resistance measured via ASTM test method D3763 and was used to establish the relationship between pellet length and impact resistance for both chopped PET fiber and continuous PET fiber feeds. The higher the total energy required to shatter the article, the greater the impact resistance.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

PO1020 is 430 MFR maleic anhydride functionalized polypropylene homopolymer containing 0.5-1.0 weight percent maleic anhydride.

PP7905E1 is 85 MFR impact copolymer commercially available from ExxonMobil Chemical Company of Baytown, Tex.

Cimpact CB7 is a surface modified talc, V3837 is a high aspect ratio talc, and Jetfine 700 C is a high surface area talc, all available from Luzenac America Inc. of Englewood, Colo.

HTP1c is a 1.5 um particle size non-surface modified talc with an aspect ratio of between 2 to 3:1 available from Imi Fabi.

### Illustrative Examples 1-8

Varying amounts of PP3505G and 0.25″ (6.4 mm) long polyester fibers were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | | | | Instrumented |
|---|---|---|---|---|
| Example | wt % | wt % | Total Energy | Impact Test |
| # | PP3505G | Fiber | (ft-lbf) | Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | Brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 0.25″ (6.4 mm) long polyester fibers were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact. The total energy absorbed and impact results are given in Table 2.

In Examples 12-14, PP8114 was extruded and injection molded under the same conditions as those for Examples 9-11. The total energy absorbed and impact results are given in Table 2.

TABLE 2

| | | | |
|---|---|---|---|
| | | Total | Instrumented |
| Example | Impact Conditions/Applied | Energy | Impact Test |
| # | Energy | (ft-lbf) | Results |

35 wt % PP7805 (70 MFR), 20 wt % talc, 45 wt % fiber

| | | | |
|---|---|---|---|
| 9 | −29° C., 15 MPH, 25 lbs/192 ft-lbf | 16.5 | ductile* |
| 10 | −29° C., 28 MPH, 25 lbs/653 ft-lbf | 14.2 | ductile* |
| 11 | −29° C., 21 MPH, 58 lbs/780 ft-lbf | 15.6 | ductile* |

100 wt % PP8114 (22 MFR)

| | | | |
|---|---|---|---|
| 12 | −29° C., 15 MPH, 25 lbs/192 ft-lbf | 32.2 | ductile* |
| 13 | −29° C., 28 MPH, 25 lbs/653 ft-lbf | 2.0 | brittle** |
| 14 | −29° C., 21 MPH, 58 lbs/780 ft-lbf | 1.7 | brittle** |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit to form a kneading block. The die was ¼″ in diameter. Strands of continuous 27,300 denier PET fibers were fed directly from spools into the hopper of the extruder, along with PP7805 and talc. The kneading elements in the kneading block in the extruder broke up the fiber in situ. The extruder speed was 400 revolutions per minute, and the temperatures across the extruder were held at 190° C. Injection molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | | | |
|---|---|---|---|---|
| Test | PET fiber-reinforced | | Example 16 | |
| (Method) | PP7805 with talc | | PP8224 | |
| Flexural Modulus, Chord | 525,190 | psi | 159,645 | psi |
| (ISO 178) | | | | |
| Instrumented Impact at −30° C. | 6.8 | J | 27.5 | J |
| Energy to maximum load | | | | |
| 100 lbs at 5 MPH | | | | |
| (ASTM D3763) | | | | |
| Notched Charpy Impact | 52.4 | kJ/m² | 5.0 | kJ/m² |
| at −40° C. | | | | |
| (ISO 179/1eA) | | | | |
| Heat Deflection Temperature | 116.5° | C. | 97.6° | C. |
| at 0.45 Mpa, edgewise | | | | |
| (ISO 75) | | | | |

| | | |
|---|---|---|
| Coefficient of Linear Thermal | 2.2/12.8 | 10.0/18.6 |
| Expansion, −30° C. to 100° C., | (E-5/° C.) | (E-5/° C.) |
| Flow/Crossflow | | |
| (ASTM E831) | | |

### Illustrative Examples 17-18

In Examples 17-18, 30 wt % of either PP3505G or PP8224, 15 wt % 0.25″ (6.4 mm) long polyester fibers, and 45 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 4.

TABLE 4

| | | | Instrumented Impact |
|---|---|---|---|
| | | Flexural | at −30° C. |
| | | Modulus, | Energy to maximum load |
| | | Chord, psi | 25 lbs at 15 MPH |
| Example | Polypropylene, | (ISO 178) | (ASTM D3763), ft-lb |
| 17 | PP8224 | 433840 | 2 |
| 18 | PP3505 | 622195 | 2.9 |

The rubber toughened PP8114 matrix with PET fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ (6.4 mm) long polyester fibers, and 10-60 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

In examples 19-24, the samples displayed no splintering in drop weight testing at an −29° C., 15 miles per hour at 25 pounds.

### Illustrative Examples 25-26

Two materials, one containing 10% ¼ inch (6.4 mm) polyester fibers, 35% PP3505 polypropylene and 60% V3837 talc (example 25), the other containing 10% ¼ inch (6.4 mm) polyester fibers, 25% PP3505 polypropylene homopolymer (example 26), 10% PO1020 modified polypropylene were molded in a Haake twin screw extruder at 175° C. They were injection molded into standard ASTM A370 ½ inch wide sheet type tensile specimens. The specimens were tested in tension, with a ratio of minimum to maximum load of 0.1, at flexural stresses of 70 and 80% of the maximum stress.

TABLE 6

| Percentage of | | |
|---|---|---|
| Maximum Stress to | Example 25, | Example 26, |
| Yield Point | Cycles to failure | Cycles to failure |
| 70 | 327 | 9848 |
| 80 | 30 | 63 |

The addition of the modified polypropylene is shown to increase the fatigue life of these materials.

### Illustrative Examples 27-29

A Leistritz 27 mm co-rotating twin screw extruder with a ratio of length to diameter of 40:1 was used in these experiments. The process configuration utilized was as depicted in FIG. 2. The screw configuration used is depicted in FIG. 4, and includes an arrangement of conveying and kneading elements. Talc, polypropylene and PET fiber were all fed into the extruder feed hopper located approximately two diameters from the beginning of the extruder screws (19 in the FIG. 3). The PET fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin pellets produced were injection molded and displayed the following properties:

TABLE 7

| | Example 27 | |
|---|---|---|
| Specific Gravity | 1.3 | |
| Tensile Modulus, Chord @ 23° C. | 541865 | psi |
| Tensile Modulus, Chord @ 85° C. | 257810 | psi |
| Flexural Modulus, Chord @ 23° C. | 505035 | psi |
| Flexural Modulus, Chord @ 85° C. | 228375 | psi |
| HDT @ 0.45 MPA | 116.1° | C. |
| HDT @ 1.80 MPA | 76.6° | C. |
| Instrumented impact @ 23° C. | 11.8 | J D** |
| Instrumented impact @ −30° C. | 12.9 | J D** |

**Ductile failure with radial cracks

In example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET fiber were negatively impacted during extrusion compounding such that the PET/PP composite resin had poor instrumented impact test properties.

In example 29, the fiber was fed into a hopper placed 14 diameters down the extruder (27 in the FIG. 3). In this case, the extrudate produced was irregular in diameter and broke an average once every minute as it was pulled through the quenching water bath. When the PET fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester fiber.

The PP composite resin pellets produced while all temperature zones of the extruder were set to 120° C. were injection molded and displayed the following properties:

TABLE 8

| | Example 30 | |
|---|---|---|
| Flexural Modulus, Chord @ 23° C. | 467,932 | psi |
| Instrumented impact @ 23° C. | 8.0 | J D** |
| Instrumented impact @ −30° C. | 10.4 | J D** |

**Ductile failure with radial cracks

### Illustrative Examples 31-34

4% Granite Fleck, which is a masterbatch of dark polymer fiber in a low density polyethylene carrier resin, was extrusion compounded with a twin screw extruder into both polypropylene based impact copolymer (PP 8114) (control sample) and also into a blend of PP homopolymer/PET fiber/talc (40% PP3505G polypropylene, 15% PET reinforcing fiber (¼″ (6.4 mm) length), and 41% Luzenac Jetfine 3CA talc). Corresponding resin samples without the incorporation of the colorant fiber masterbatch (no Granite Fleck) were also produced to assess the impact of the colorant fiber on impact properties for the prior art PP impact copolymer and the PP-PET fiber reinforced composite disclosed herein. The fiber reinforced polypropylene composite without the colorant fiber included 40% PP3505G polypropylene, 15% PET reinforcing fiber (¼″ (6.4 mm) length), and 45% Luzenac Jetfine 3CA talc.

These four resin samples were molded in accordance with the geometry of ASTM D3763 and tested for instrumented impact resistance and failure mode upon impact failure. The instrumented impact test results are given in Table 9.

TABLE 9

| | | | Failure | |
|---|---|---|---|---|
| | | | mode | |
| | | Instru- | during | |
| | | mented | instru- | Flexural |
| | | impact | mented | modulus |
| Example | Material Composition | (ft-lbs) | impact | (psi) |
| 31 | Impact copolymer (PP | 32.2 | Ductile | No data |
| | 8114) (prior art control w/o | | | |
| | colorant fiber) | | | |
| 32 | Impact copolymer + | 4.1 | Brittle | No data |
| | colorant fiber (PP 8114 + | | | |
| | 4% Granite Fleck) (prior | | | |
| | art control w/colorant fiber) | | | |
| 33 | PP/PET fiber/talc | 11.9 | Ductile | 609,000 |
| | composite (40% PP | | | |
| | 3505G/15% PET fiber/45% | | | |
| | talc) (present disclosure | | | |
| | w/o colorant fiber) | | | |
| 34 | PP/PET fiber/talc/colorant | 12.6 | Ductile | 606,000 |
| | fiber composite (40% PP | | | |
| | 3505G/15% PET fiber/41% | | | |
| | talc/4% Granite Fleck) | | | |
| | (present disclosure + | | | |
| | colorant fiber) | | | |

From Table 9, it is important to note that upon the incorporation of the colorant fiber into the impact polymer (Example 32) of the prior art, there is approximately a 88% decrease in instrumented impact resistance, and also the failure mode goes from ductile (no splintering) to brittle (splintering). In contrast, when colorant fiber is added to the PP/PET fiber/talc composition material (Example 34) of the present disclosure, there is no decrease in instrumented impact resistance, while the failure mode remains ductile in nature, with negligible reduction in flexural modulus. The PP/PET fiber/talc/colorant fiber composite material after molding also has a cloth-like look to it from the incorporation of the dark colorant fiber uniformly dispersed through the molded object. Surprisingly, the PP/PET fiber/talc/colorant fiber composite material (Example 34) retains its outstanding impact resistance unlike the prior art rubber modified PP impact copolymer/colorant fiber sample (Example 32).

### Illustrative Examples 35 and 36

Two processes have been developed to extrude pellets of polyester fiber reinforced polypropylene. One process involves introducing cut PET fiber into the twin screw extruder, while the second involves introducing continuous PET fiber unwound from spools into the extruder hopper of the twin screw extruder, which is then cut in situ in the extruder by the twin screws. The following examples illustrate the effect of PET fiber reinforced polypropylene resin pellet length and process type for introducing PET fiber on the impact properties of the resulting composite. In the case of cut fiber, 15% by weight of 7.1 denier ¼ inch (6.4 mm) long polyester fiber was mixed with 40% high aspect ratio talc (Luzenac Inc.), 40% of an impact copolymer PP 7905 from ExxonMobil Chemical company which has a melt flow rate (mfr) of 90 mfr in accordance with ASTM D1238, and 5% of PO1020 from ExxonMobil Chemical Company, a maleic anhydride grafted polypropylene with mfr of 430 in accordance with ASTM D1238. All these materials were dry mixed in a bag and fed through the hopper of a laboratory model Haake extruder run at 200 revolutions per minute, with temperatures at 175° C. across all temperature zones. In the case of continuous fiber cut in situ within the extruder, the extruder was run in accordance with the description of examples 27-29, but with the same composition as described here, and with all zones across the extruder held at 120° C.

The PET reinforced polypropylene composite resins were made into pellet sizes ranging from 3.2 mm to 12.7 mm by varying the pelletizing conditions. For Examples 35 and 36, resin samples were collected for pellet lengths of 3.2, 6.4, 9.5 and 12.7 mm. All samples were subsequently injection molded in a 50 ton Boy machine. All heating zones were held at 401° C., with the mold at 60° C. Total cycle time was 5.1 seconds. For each example and pellet size, dart drop impact energy was measured by determining the total energy to break (in newton meter) via ASTM Test Method D3763. For each process type and pellet length, ten samples were tested. Table 10 below summarizes the total energy to break as a function of PET fiber feed type and pellet length.

The results in Table 10 indicate that the optimum pellet length to attain the highest value of drop dart impact resistance varies depending upon whether continuous PET fiber (Example 35) or chopped PET fiber (Example 36) was fed into the twin screw compounding extruder prior to pelletizing. In the case of input continuous PET fiber, the optimum pellet length was from about 6.4 to 9.5 mm in length and drop dart impact values of 7.9 to 9.6 newton meter were achieved. In the case of input cut PET fiber, the optimum pellet length was from 9.5 mm to 12.7 mm in length and drop dart impact values of 12.9 to 13.4 newton meter were achieved. However, in both cases (continuous and chopped PET fiber input), even PET reinforced polypropylene pellets as small as 3.2 mm in length were sufficient to pass the impact test, defined as no splinters or shards breaking off the sample after impact (ductile failure with radial cracks and no splintering). In addition, the impact data in Table 10 indicates that feeding chopped PET fiber consistently results in higher impact resistance than feeding continuous PET rovings at any given pellet length.

TABLE 10

| | | | | |
|---|---|---|---|---|
| | Total Energy - | | Total Energy - | |
| | Run 1 | | Run 2 | |
| Pellet | (Units: ft-lb_{f} | | (Units: ft-lb_{f} | |
| Length | (newton meter)) | Std Dev. | (newton meter)) | Std. Dev |

Example 35:

| | | | | | |
|---|---|---|---|---|---|
| Continuous | ⅛″ | 5.2 (7.1) | 2.65 | 4.4 (6.0) | 1.8 |
| Fiber feed | (3.2 mm) | | (3.59) | | (2.4) |
| | ¼″ | 7.1 (9.6) | 1.8 | 6.1 (8.3) | 1.3 |
| | (6.4 mm) | | (2.4) | | (1.8) |
| | ⅜″ | 6.4 (8.7) | 1.5 | 5.8 (7.9) | 1.8 |
| | (9.5 mm) | | (2.0) | | (2.4) |
| | ½″ | 5.3 (7.2) | 2.2 | 3.9 (5.3) | 0.6 |
| | (12.7 mm) | | (3.0) | | (0.8) |

Example 36:

| | | | | | |
|---|---|---|---|---|---|
| ¼″(6.4 mm) | ⅛″ | 6.9 (9.4) | 2.1 | 7.2 (9.8) | 1.7 |
| cut fiber feed | (3.2 mm) | | (2.8) | | (2.3) |
| | ¼″ | 8.6 (11.7) | 2 | 7.6 (10.3) | 1.9 |
| | (6.4 mm) | | (2.7) | | (2.6) |
| | ⅜″ | 9.9 (13.4) | 1 | 9.8 (13.3) | 0.8 |
| | (9.5 mm) | | (1.4) | | (1.1) |
| | ½″ | 9.8 (13.3) | 1.1 | 9.5 (12.9) | 2.5 |
| | (12.7 mm) | | (1.5) | | (3.4) |

### Illustrative Examples 37-55

85% by weight of PP7905 and 15% by weight of 6 denier high tenacity polyester fiber of various pre-cut input fiber lengths (⅛″, ¼″, ½″, and ¾″) were mixed in a Haake twin screw extruder at 175° C. The strand that exited the extruder was cut into various pellet lengths (⅛″, ¼″, ⅜″, ½″, and ¾″) and injection molded using a Boy 50M ton injection molder at 205° C. into a mold held at 60° C. For each input cut fiber length, a sample of the unpelletized extrudate was produced and injection molded as well. Injection pressures and nozzle pressures were maintained at 2300 psi. Samples were molded in accordance with the geometry of ASTM D3763 and tested for instrumented impact at room temperature under the following conditions for interior parts: 25 lbs, at 15 MPH, at 23 C. The total energy absorbed via impact results in foot-pounds force and newton-meter as a function of pellet length and cut-fiber length are given in Table 11 below.

TABLE 11
Total energy
absorbed
(Units: ft-lb_{f}

| (N-m)) | Pellet Length | | | | | |
|---|---|---|---|---|---|---|
| Cut-fiber | ⅛″ | ¼″ | ⅜″ | ½″ | ¾″ | |
| length | (3.2 mm) | (6.4 mm) | (9.5 mm) | (12.7 mm) | (19.1 mm) | Unpelletized |
| ⅛″ (3.2 mm) | 5.6 | 4.5 | 5.5 | 5.4 | 5.8 | 4.7 |
| | (7.6) | (6.1) | (7.5) | (7.3) | (7.9) | (6.4) |
| ¼″ (6.4 mm) | 6.6 | 7.7 | 4.7 | 7.1 | 5.6 | 6.4 |
| | (8.9) | (10.4) | (6.4) | (9.6) | (7.6) | (8.7) |
| ½″ (12.7 mm) | 7 | 7.4 | 9.4 | 8.7 | 8.3 | 9 |
| | (9.5) | (10.0) | (12.7) | (11.8) | (11.3) | (12.2) |
| ¾″ (19.1 mm) | | | | | | 9 |
| | | | | | | (12.2) |

In addition, all the samples (37 to 55) tested for drop dart impact exhibited ductile failures with radial cracks. In other words, none of the samples displayed splintering upon failure. The results also indicate that increased input chopped fiber length results in high impact resistance as 12.7 mm long chopped fiber yielded the highest impact values. When 12.7 mm long chopped fiber is used, the results also indicate that resin pellet lengths of 9.5 to 12.7 mm yielded the highest impact resistance values.

### Illustrative Examples 56 and 57

85% by weight of PP7905 and 15% by weight of 3.1 denier staple tenacity polyester fiber of ¼ inch (3.2 mm) cut fiber length were mixed in a Haake twin screw extruder at 175° C. The strand that exited the extruder was cut into ¼ inch (3.2 mm) pellet lengths and injection molded using a Boy 50M ton injection molder at 205° C. into a mold held at 60° C. A sample of the unpelletized extrudate was also produced and injection molded. Injection pressures and nozzle pressures were maintained at 2300 psi. Samples were molded in accordance with the geometry of ASTM D3763 and tested for instrumented impact at room temperature under the following conditions for interior parts: 25 lbs, at 15 MPH, at 23 C. In addition, the number of samples that did not splinter (# pass) and the number of sample that did splinter (# fail) upon instrumented impact testing were noted and shown below in Table 12. The total energy absorbed during impact testing in foot-pounds force and Newton-meter is also given in Table 12 below.

TABLE 12

| | Impact energy absorbed | |
|---|---|---|
| Sample | (Units: ft-lb_{f}(N-m)) | # pass/#fail |
| ¼″ (6.4 mm) pellet length | 3.3 (4.5) | 4/1 |
| Unpelletized continuous | 3.5 (4.7) | 1/4 |
| extrudate | | |

The results indicate that the low denier (3.1) PET fiber yields poorer impact results compared to higher denier PET fiber (See Examples 35-55). In particular, the impact energy absorbed for the low denier (3.1) PET fiber is lower than the higher denier (6.0 and 7.1 denier) PET fiber of Examples 35-55. In addition, the low denier PET samples exhibited failure (splintering) in one or more samples upon impact testing as compared to no splintering for the higher denier PET fiber samples of Examples 35-55. Hence, a higher loading of PET fiber (20% or more) in the PP matrix polymer is needed to achieve acceptable impact test results when using an input lower denier PET fiber (3.1 denier) as compared to an input higher denier PET fiber (6 and 7.1 denier). It is predicted that a fiber loading of 20% or more of low denier (3.1) PET fiber in a PP matrix polymer should yield impact energies of at least 5.0 newton meter, and possibly at least 5.5 newton meter when smaller pellet sizes are produced for subsequent molding and impact testing.

### Illustrative Examples 58 to 61

In this set of experiments, 6 mm long pre-cut PET fibers were fed with a Schenk gravimetric feeder to a compounding extruder. The 6 mm cut PET fiber was loaded into the main feed hopper of the system. In the main feed hopper was a single conditioning agitator with 4 arms that protrude from the axis radially and then bend 90° as shown in FIG. 5. The conditioning agitator in the hopper was situated directly above the metering auger or screw of the feeder. The metering auger or screw employed for this application was a spiral type auger with no center shaft. The diameter of the metering auger was 50 mm and the distance between flights was 38 mm. The pre-cut PET fibers were fed directly into the main feed throat of a twin screw extruder, dropping a distance of approximately 10-12 feet. PP resin and talc were also fed via separate feeders into the main feed throat of the extruder. The twin screw extruder used was a Coperion ZSK53 mm. The screws included two mixing zones. The length to diameter ratio of the twin screw extruder was 30:1. The screws were run at 300 rpm. The temperature of the barrels was set at 180° C. and the die temperature was 220° C.

The twin screw extruder was equipped with a strand pelletizer. The die used for experiments with PP3546G had 6 mm diameter die holes and the die for the experiments with ICP granules had 3.4 mm diameter die holes. Strands were pelletized to nominal lengths of 12 mm. Target production rate was 80 kg/hr. The fiber feed rate was set at 12 kg/hr. It was noted that the fiber feed was not free-flowing. The cut PET fibers would tend to “clump” and drop as “clumps” into the extruder. Thus the instantaneous rate of PET fiber addition would vary from zero to much higher than the target rate of 12 kg/hr. However, because the PET fiber was being mixed in with the polymer resin in the extruder, it was found that the resulting fiber reinforced PP composites had adequate fiber dispersion. There was some bridging of pre-cut PET fiber between the feeder hopper and the metering auger because of the use of the rotating conditioning agitator in the feeder hopper prior to the metering auger.

Four experimental resin samples were injection molded into discs 3.2 mm thick (per ASTM D3763) and impact tested at room temperature (15 mph, 15 lbs). All samples exhibited ductility during impact testing and did not shatter or split as a result of impact with no pieces coming off of the specimen. Fiber reinforced resin samples produced and corresponding test results are indicated in Table 13 below.

TABLE 13

| | Example | | | |
|---|---|---|---|---|
| | 58 | 59 | 60 | 61 |
| PP Source | PP3546G | PP3546G | PP3546G | PP3546G |
| PP wt % | 55% | 53% | 53% | 53% |
| Talc Source | HTP1C | HTP1C | HTP1C | HTP1C |
| Talc wt % | 30% | 30% | 30% | 30% |
| Fiber Length | 6 mm | 12 mm | 6 mm | 6 mm |
| Fiber wt % | 15% | 15% | 15% | 15% |
| PO1020 wt % | | 2% | 2% | 2% |
| Extruder Barrel | 215 | 215 | 215 | 215 |
| Temp (C.) | | | | |
| Impact Testing | | | | |
| Results | | | | |
| Impact Energy | 5.1 | 8.1 | 6.6 | 5.2 |
| (ft-lbs) | | | | |
| SD | 0.6 | 0.7 | 0.5 | 1 |
| Instrumented | Ductile* | Ductile* | Ductile* | Ductile* |
| Impact Test | | | | |
| Results | | | | |

*samples did not shatter or split as a result of impact, with no pieces coming off of the specimen.

These examples demonstrate the ability to adequately feed pre-cut organic fiber to a compounding extruder with a fiber feeder incorporating a conditioning agitator in the feeder hopper in order to produce fiber reinforced polypropylene composites with favorable properties after molding and testing.

### Illustrative Examples 62 to 69

In this set of experiments, pre-cut PET fibers were fed via an Acrison bin discharge feeder as shown in FIG. 7. In this feeder, two counter-rotating conditioning augers are positioned at the bottom of the feed chamber to assist in filling the metering auger of the feeder. The conditioning augers were 10 inch diameter and their design included a series of paddles positioned away from the center shaft in the radial direction. The metering auger had an Acrison type G conveying element, approximately 60 mm in diameter. The discharge tube in which the metering auger was placed was an Acrison type K tube with a 90 mm diameter. It was found that it was necessary for the metering auger to be much less in diameter than the discharge tube to allow ample clearance for the pre-cut fibers.

The feeder was set to deliver the cut fibers at a rate of 108 lbs/hr. This feeder provided a more consistent feed of the cut fibers than the feeder in Examples 58 to 61. The cut fiber would still fall as “clumps” but the periods of zero instantaneous feed rate were much shorter than with the Schenck feeder. The actual calculated rate based on the load-cells was observed to fluctuate between 100 and 116 lbs/hr due to the tendency of the fibers to fall as “clumps” instead of free-flowing.

In this set of experiments, a Coperion ZSK58 twin screw extruder was used to compound the fibers with PP7905E1 impact copolymer (available from ExxonMobil, 85 MFR, 10% Cv) and HTP1C talc. All material was fed into the main feed throat of the compounding extruder. The extruder was operated at maximum barrel temperatures of 210° C. and a die temperature of 250° C. The screw design consisted of a series of mixing zones to allow melting of the polymer and dispersion of the talc and fiber without adding too much energy to compromise the PET fiber properties. The extruder rpm was set at 300 rpm screw speed. It was noted that for this particular screw design, when the rpms were increased, the samples started to exhibit brittleness during impact testing. This may have been caused by the extra energy and higher localized temperatures in the extruder compromising the PET fiber properties. The extrudate was underwater pelletized with a Gala Model 6 underwater pelletizer. The die had 4 mm diameter holes. Production rate was set at 720 lbs/hr. Composite pellets were nominally ⅜″ long. There was no sign of bridging of PET cut fiber between the feeder hopper and the metering auger because of the use of the conditioning auger/agitator in the feeder hopper prior to the metering auger.

These experimental samples were molded and impact tested using the same procedure as described in Examples 58 to 61 above. Fiber reinforced resin samples produced and corresponding test results are indicated in Table 14 below.

TABLE 14

| | Example | | | | | | | |
|---|---|---|---|---|---|---|---|---|
| | 62 | 63 | 64 | 65 | 66 | 67 | 68 | 69 |
| ZSK rpm | 300 | 400 | 500 | 600 | 300 | 400 | 500 | 600 |
| PP Source | PP7905E1 | PP7905E1 | PP7905E1 | PP7905E1 | PP7905E1 | PP7905E1 | PP7905E1 | PP7905E1 |
| PP wt % | 55% | 55% | 55% | 55% | 55% | 55% | 55% | 55% |
| Talc Source | HTP1C | HTP1C | HTP1C | HTP1C | HTP1C | HTP1C | HTP1C | HTP1C |
| Talc wt % | 30% | 30% | 30% | 30% | 30% | 30% | 30% | 30% |
| PET wt % | 15% | 15% | 15% | 15% | 15% | 15% | 15% | 15% |
| Cut Fiber length | 12 mm | 12 mm | 12 mm | 12 mm | 6 mm | 6 mm | 6 mm | 6 mm |
| Max Barrel Temp. (C.) | 211 | 212 | 211 | 210 | 210 | 210 | 213 | 210 |
| Total energy (ft-lbs) | 5.8 | 4.7 | 2.4 | 2.1 | 4.3 | 4.5 | 3.1 | 2.3 |
| Instrument Impact Test | Ductile* | Marginal | Brittle** | Brittle** | Ductile* | Ductile* | Brittle** | Brittle** |
| Results | | Ductile* | | | | | | |

*Samples did not shatter or split as a result of impact, with no pieces coming off of the specimen;
**Pieces broke off of the sample as a result of the impact.

These examples again demonstrate the ability to adequately feed pre-cut fiber to a compounding extruder with a fiber feeder incorporating a conditioning auger/agitator in the feeder hopper in order to produce fiber reinforced polypropylene composites with favorable properties after molding and testing. The two counter-rotating conditioning augers positioned at the bottom of the fiber feeder hopper were also more effective in preventing bridging in the throat area leading to the metering auger in comparison to the single conditioning agitator of examples 58 to 61. Hence this form of the feeder hopper with two conditioning augers was advantageous in providing improved cut fiber feed rate consistency compared to a singe conditioning agitator.

### Illustrative Example 70

In this experiment, a Brabender Technologie loss-in-weight fiber feeder as shown in FIGS. 8 and 9 was used to test the feeding of ¼″ pre-cut PET fiber (6 and 12 denier). Using this fiber feeder, the two spiked metering rollers rotating at 2-8 rotations per minute pulled the pre-cut PET fiber downward, rather than relying on gravity. The PET fiber was then conveyed to a single separating roller. The fiber fell off the separating roller as nearly individual fibers with no fiber clumps for both the 6 and 12 denier ¼″ PET fiber. A fiber feed rate of 200 grams per minute was achieved with no fluctuations with time of output rate. After the PET fiber was fed through the fiber blender, the same material was reintroduced into the fiber feeder. The material fed just as reliably even though it was considerably fluffed out and had a far lower bulk density. These are characteristics which may have prevented issues when using conventional auger type feeders without a conditioning agitator in the feeder hopper. There was also no sign of bridging of the pre-cut PET fiber between the feeder hopper and the metering rollers.

### Comparative Example 71

In this comparative example, a Brabender loss-in-weight feeder was used to feed pre-cut PET fibers. The Brabender gravimetric feeder had a metering auger, but did not have a conditioning agitator or conditioning auger in the feeder hopper. The metering auger of the Brabender gravimetric feeder was very similar in design (spiral type auger with no center shaft) to the Schenk metering auger of illustrative examples 58 to 61 and to the Acrison metering auger of illustrative examples 62 to 69. During this comparative experiment, the average cut fiber feed rate was 2 pounds per hour, despite the fact that the Brabender gravimetric feeder was set to run at 10 pounds/hour. In addition, the cut fiber feed rate was very inconsistent, with periods of up to five seconds with no fiber at all being fed and with accompanying clumping of fiber at other periods.

This comparative example illustrated the importance of using a conditioning auger/agitator or a vibrating means/mechanism in the feeder hopper to feed pre-cut organic fiber when using a feeder with a metering auger. Without the use of the conditioning auger/agitator or a vibrating means/mechanism in the feeder, the cut fiber feed rate was very inconsistent, and the cut fiber tended to clump up. Bridging in the feeder hopper of the pre-cut fiber when not using a conditioning auger/agitator or a vibrating means/mechanism in the feeder hopper was the likely the cause of the feeding difficulties in this comparative example.

### Illustrative Example 72

In this set of experiments, pre-cut PET fibers were fed to an extruder via a Brabender fiber feeder as shown in FIGS. 8 and 9. The feeder was set to deliver the cut fibers at a rate of 86 lbs/hr. This feeder provides a more consistent fiber feed to the extruder than the feeder in Examples 62-69. The fiber discharged from the feeder in a uniform rate with no periods of zero instantaneous feed rate. The feed rate only fluctuated from 85-87 lbs/hr.

In this set of experiments, pre-cut PET fibers were fed to an extruder via a Brabender fiber feeder as shown in FIGS. 8 and 9. The feeder was set to deliver the cut fibers at a rate of 86 lbs/hr. This feeder provides a more consistent fiber feed to the extruder than the feeder in Examples 62-69. The fiber discharged from the feeder in a uniform rate with no periods of zero instantaneous feeding. The feed rate only fluctuated from 85-87 lbs/hr.

A Coperion ZSK58 twin screw extruder was used to compound the fibers with PP7905E1 impact copolymer (available from ExxonMobil, 85 MFR, 10% Cv), HTP1c talc, PO1020 modified polypropylene, and slip agent. The PP7905E1, PO1020, talc and slip agent were all fed in the main feed throat of the extruder. The fiber was added to the melt in the extruder halfway down the extruder via a Coperion ZSB58 side feeder. The side feeder consisted of two corotating screws that were able to feed the fibers after being metered by the Brabender fiber feeder.

The extruder operated at a maximum barrel temperature of 230° C. prior to the fiber introduction. At the barrel section where the fiber entered the melt and all downstream barrels, the barrel temperature was set to a maximum of 170° C. The extruder screw design consisted of a first mixing zone to melt the PP and disperse talc prior to introduction of the fiber. Downstream of the fiber side feeder there was another mixing area to insure dispersion of the fiber. The extruder screw rpm was set to 400 rpm to insure no damage to the fibers by shear forces. The extrudate was underwater pelletized with a Gala Model 6 underwater pelletizer. The die had 4 mm diameter holes. Production rate was set at 575 lbs/hr. Composite pellets were nominally ⅜″ long.

The experimental samples were molded and impact tested using the same procedures as described in Examples 58 to 61. Fiber reinforced resin samples produced and corresponding test results are indicated in Table 15 below.

TABLE 15

| Example | 72 |
|---|---|
| ZSK rpm | 400 |
| PP Source | PP7905E1 |
| PP/PO1020 wt % | 55% |
| Talc Source | HTP1C |
| Talc wt % | 30% |
| PET wt % | 15% |
| Cut Fiber length | 6 mm |
| Max Barrel Temp. (C.) | 230 |
| Total energy (ft-lbs) | 7.9 |
| Instrument Impact | Ductile* |
| Test Results | |

*Samples did not shatter or split as a result of impact, with no pieces coming off of the specimen

These examples demonstrate the ability to adequately feed pre-cut fiber to a compounding extruder with a Brabender fiber feeder. Since this feeder provides a more consistent, uniform fiber feed, the final product also has a more uniform fiber concentration.

Applicants have attempted to disclose all embodiments and applications of the disclosed subject matter that could be reasonably foreseen. However, there may be unforeseeable, insubstantial modifications that remain as equivalents. While the present disclosure has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. A method for making fiber reinforced polypropylene composite pellets comprising:
(a) feeding into a compounding extruder at least 25 wt % polypropylene based polymer, from 5 to 60 wt % pre-cut organic fiber, and from 0 to 60 wt % inorganic filler, based on the total weight of the composition;
(b) extruding the polypropylene based resin, the pre-cut organic fiber, and the inorganic filler through the compounding extruder to form a fiber reinforced polypropylene composite melt;
(c) cooling the fiber reinforced polypropylene composite melt to form a solid fiber reinforced polypropylene composite, and
(d) pelletizing the solid fiber reinforced polypropylene composite to form fiber reinforced polypropylene composite pellets;
wherein the pre-cut organic fiber is fed from a feeder including a feeder hopper, one or more conditioning augers/agitators within the feeder hopper, one or more metering augers below the feeder hopper within a housing, and a means for controlling the speed of the conditioning augers/agitators and metering augers; and
wherein an article molded from the pellets has a flexural modulus of at least 2.07 GPa and exhibits ductility during instrumented impact testing.

2. The method of claim 1, wherein the feeder further includes one or more rotating pickers positioned downstream of the one or more metering augers.

3. The method of claim 2, wherein the feeder controls fiber output rate via volumetric output or loss-in-weight of the feeder hopper using closed loop feedback control to the speed of the one or more metering augers.

4. The method of claim 3, wherein the one or more metering augers are a spiral design with no center shaft.

5. The method of claim 4, wherein the one or more conditioning augers/agitators include one or more spiral type blades, one or more paddle type blades, and combinations thereof.

6. The method of claim 5, wherein the one or more conditioning augers/agitators further include a means for vibrating the augers/agitators.

7. The method of claim 1, wherein the feeder hopper further includes a means for vibrating the hopper.

8. The method of claim 1, wherein the feeder feeds the pre-cut organic fiber into the compounding extruder at the extruder hopper or at a downstream feed port in the extruder.

9. The method of claim 1, wherein the polypropylene based polymer is chosen from polypropylene homopolymers, propylene-ethylene random copolymers, propylene-butene-1 random copolymers, propylene-hexene-1 random copolymers, propylene-octene-1 random copolymers, propylene-α-olefin random copolymers, propylene impact copolymers, ethylene-propylene-butene-1 terpolymers, and combinations thereof.

10. The method of claim 9, wherein the polypropylene based polymer is polypropylene homopolymer with a melt flow rate of from 20 to 2000 g/10 minutes.

11. The method of claim 1, wherein the pre-cut organic fiber is chosen from polyalkylene terephthalates, polyalkylene naphthalates, polyamides, polyolefins, polyacrylonitrile, and combinations thereof.

12. The method of claim 11, wherein the pre-cut organic fiber is polyethylene terephthalate with a length of from 3.2 to 25.4 mm.

13. The method of claim 1, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

14. The method of claim 1, wherein the compounding extruder comprises barrel temperature control set points of less than or equal to 215° C.

15. A method for making fiber reinforced polypropylene composite pellets comprising:
(a) feeding into a compounding extruder at least 25 wt % polypropylene based polymer, from 5 to 60 wt % pre-cut organic fiber, and from 0 to 60 wt % inorganic filler, based on the total weight of the composition;
(b) extruding the polypropylene based resin, the pre-cut organic fiber, and the inorganic filler through the compounding extruder to form a fiber reinforced polypropylene composite melt;
(c) cooling the fiber reinforced polypropylene composite melt to form a solid fiber reinforced polypropylene composite, and
(d) pelletizing the solid fiber reinforced polypropylene composite to form fiber reinforced polypropylene composite pellets;
wherein the pre-cut organic fiber is fed from a feeder including a feeder hopper, two or more counter-rotating metering rollers within a housing below the feeder hopper, one or more separating rollers within the housing below the metering rollers, and a means for controlling the speed of the metering rollers and separating rollers; and
wherein an article molded from the pellets has a flexural modulus of at least 2.07 GPa and exhibits ductility during instrumented impact testing.

16. The method of claim 15, wherein the metering rollers and separating rollers include pins protruding from the surface around the circumference of the rollers.

17. The method of claim 16, wherein the metering rollers rotate from 1 to 20 rpms to stabilize the pre-cut organic fiber and meter it to the separating rollers.

18. The method of claim 17, wherein the separating rollers rotate at a speed greater than 50 rpms to produce a flow of individual pre-cut organic fibers to the compounding extruder.

19. The method of claim 18, wherein the feeder controls fiber output rate via loss-in-weight of the feeder hopper using closed loop feedback control to the speed of the one or more metering rollers.

20. The method of claim 15, wherein the feeder hopper further includes one or more conditioning augers/agitators.

21. The method of claim 20, wherein the one or more conditioning augers/agitators include one or more spiral type blades, one or more paddle type blades, and combinations thereof.

22. The method of claim 21, wherein the one or more conditioning augers/agitators further include a means for vibrating the augers/agitators.

23. The method of claim 15, wherein the feeder hopper further includes a means for vibrating the hopper.

24. The method of claim 15, wherein the feeder feeds the pre-cut organic fiber into the compounding extruder at the extruder hopper or at a downstream feed port in the extruder.

25. The method of claim 15, wherein the polypropylene based polymer is chosen from polypropylene homopolymers, propylene-ethylene random copolymers, propylene-butene-1 random copolymers, propylene-hexene-1 random copolymers, propylene-octene-1 random copolymers, propylene-α-olefin random copolymers, propylene impact copolymers, ethylene-propylene-butene-1 terpolymers, and combinations thereof.

26. The method of claim 25, wherein the polypropylene based polymer is polypropylene homopolymer with a melt flow rate of from 20 to 2000 g/10 minutes.

27. The method of claim 15, wherein the pre-cut organic fiber is chosen from polyalkylene terephthalates, polyalkylene naphthalates, polyamides, polyolefins, polyacrylonitrile, and combinations thereof.

28. The method of claim 27, wherein the pre-cut organic fiber is polyethylene terephthalate with a length of from 3.2 to 25.4 mm.

29. The method of claim 15, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

30. The method of claim 15, wherein the compounding extruder comprises barrel temperature control set points of less than or equal to 215° C.

31. A method for making fiber reinforced polypropylene composite pellets comprising:
(a) feeding into a compounding extruder at least 25 wt % polypropylene based polymer, from 5 to 60 wt % pre-cut organic fiber, and from 0 to 60 wt % inorganic filler, based on the total weight of the composition;
(b) extruding the polypropylene based resin, the pre-cut organic fiber, and the inorganic filler through the compounding extruder to form a fiber reinforced polypropylene composite melt;
(c) cooling the fiber reinforced polypropylene composite melt to form a solid fiber reinforced polypropylene composite, and
(d) pelletizing the solid fiber reinforced polypropylene composite to form fiber reinforced polypropylene composite pellets;
wherein the pre-cut organic fiber is fed from a circle feeder including a circle feeder hopper positioned above the circle feeder; and
wherein an article molded from the pellets has a flexural modulus of at least 2.07 GPa and exhibits ductility during instrumented impact testing.

32. The method of claim 31, wherein the circle feeder further includes one or more rotating pickers positioned downstream of the circle feeder.

33. The method of claim 31, wherein the circle feeder controls fiber output rate via speed of a rotating shaft connected to central rotary vanes and the height of a flow adjusting ring.

34. The method of claim 31, wherein the circle feeder hopper further includes a means for vibrating the hopper.

35. The method of claim 31, wherein the polypropylene based polymer is chosen from polypropylene homopolymers, propylene-ethylene random copolymers, propylene-butene-1 random copolymers, propylene-hexene-1 random copolymers, propylene-octene-1 random copolymers, propylene-α-olefin random copolymers, propylene impact copolymers, ethylene-propylene-butene-1 terpolymers, and combinations thereof.

36. The method of claim 35, wherein the polypropylene based polymer is polypropylene homopolymer with a melt flow rate of from 20 to 2000 g/10 minutes.

37. The method of claim 31, wherein the pre-cut organic fiber is chosen from polyalkylene terephthalates, polyalkylene naphthalates, polyamides, polyolefins, polyacrylonitrile, and combinations thereof.

38. The method of claim 37, wherein the pre-cut organic fiber is polyethylene terephthalate with a length of from 3.2 to 25.4 mm.

39. The method of claim 31, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

40. The method of claim 31, wherein the compounding extruder comprises barrel temperature control set points of less than or equal to 215° C.
